(19) United States
(12) Patent Application Publication
(10) Pub. No.: US 2026/0209444 A1
(43) Pub. Date: Jul. 23, 2026

(54) SILOXANE-BASED DISPERSING COMPOSITIONS AND METHODS THEREOF

(71) Applicants: THE TEXAS A&M UNIVERSITY SYSTEM, College Station, TX (US); TRI AUSTIN, INC., Austin, TX (US)

(72) Inventors: Melissa GRUNLAN, College Station, TX (US); Alec MARMO, College Station, TX (US); Spencer HAWKINS, Austin, TX (US)

(21) Appl. No.: 19/139,446

(22) PCT Filed: Dec. 15, 2023
(86) PCT No.: PCT/US2023/084265

§ 371 Date: Jun. 16, 2025

Related U.S. Application Data
(60) Provisional application No. 63/387,750, filed on Dec. 16, 2022.

(51) Int. Cl. C08G 77/38; C08K 3/013

(52) U.S. Cl. CPC C08G 77/38; C08K 3/013

(57) ABSTRACT

The present disclosure provides amphiphilic siloxane compounds including a siloxane tether segment and a polymer segment. Mixtures including an amphiphilic siloxane compound blended with a base polymer and a filler are also provided, as well as associated methods utilizing the compounds and mixtures.

### CROSS-REFERENCE TO RELATED APPLICATIONS

This application claims the benefit under 35 USC § 119(e) of U.S. Provisional Application Ser. No. 63/387,750, filed on Dec. 16, 2022, the entire disclosure of which is incorporated herein by reference.

### GOVERNMENT RIGHTS

This invention was made with government support under RO1HL151240 awarded by the National Institute of Health. In addition, this invention was made with government support under N6833521C0816 awarded by the U.S. Navy. In addition, this invention was made with government support under FA8650-23-C-5002 SBIR awarded by the Department of Defense. The government has certain rights in the invention.

### BACKGROUND AND SUMMARY OF THE INVENTION

Composite materials, particularly those comprising polymers, are important facets for many different industries. A superior performance of fillers contained in polymer matrices can be realized by utilizing dispersing agents. For instance, superior performance via mechanical, electrical, surface, and optical properties can be realized by using dispersing agents.

Generally, dispersing agents are amphiphilic in nature and can comprise a hydrophobic portion and a hydrophilic portion. The dispersing agent can be blended with polymers such as polymer matrices to form free-standing compositions such as composites, coatings, paints, and the like. Importantly, the dispersing agents are compatible with the polymers and thus avoids negative aspects of phase separation.

In a particular aspect, flexible and dry skin electrodes can be formed using a facile method for dispersing carbon nanotubes (CNTs) in a silicone matrix using custom amphiphilic dispersive additives (DSPAs). These compositions represent a potentially superior alternative to standard Ag/AgCl metal electrodes for traditional wearable devices that are currently used in long-term monitoring. As described herein, the poly(ethylene oxide)-silanes (PEO-SA) modified silicone-CNT composites demonstrated improved conductivity compared to the unmodified composites. Further, modified composites retained their moduli, rather than becoming more rigid. Resultant electrodes fabricated with modified composites showed skin-electrode impedance comparable to that of Ag/AgCl electrodes. Without being bound by any theory, the present disclosure demonstrates the potential of silicone-CNT composites prepared with PEO-SA DSPAs as flexible, dry electrodes as a superior alternative to traditional electrodes.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A shows a diagrammatic illustration of twelve amphiphilic poly(ethylene oxide)-silanes (PEO-SAs) in accordance with the present disclosure.

FIG. 1B shows a diagrammatic scheme of the preparation of silicone-CNT composites for dry, flexible skin electrodes using amphiphilic PEO-silane (PEO-SA) dispersive additives (DSPAs) in accordance with the present disclosure.

FIG. 2 shows a representative scheme of the synthesis of amphiphilic PEO-silane (PEO-SA) dispersive additives (DSPAs). HDMSₘ (hydride terminated oligo(dimethylsiloxane)-b-PEO); Triblock [DMS]ₘ (PEO-b-oligo(dimethylsiloxane)-b-PEO); 1-Star [DMS]ₘ, (one-arm, oligo(dimethylsiloxane)-b-PEO); 2-Star [DMS]m (two-arm, oligo(dimethylsiloxane)-b-PEO); 3-Star [DMS]m (three-arm, oligo(dimethylsiloxane)-b-PEO); 4-Star [DMS]ₘ (four-arm, oligo(dimethylsiloxane)-b-PEO).

FIG. 3 shows a representative graph of conductivity of silicone-CNT films (frequency=10⁰-10⁷ Hz). “Unmodified” refers to silicone-CNT composite formed without a PEO-SA. Other composites are designated by the PEO-SA used for fabrication.

FIG. 4 shows a representative graph of impedance of films comprised of unmodified silicone-CNT composite (Sylgard 184), and silicone-CNT composites modified with PEO-SAs over frequency sweep from 10⁰-10⁷ Hz.

FIG. 5A shows a representative SEM micrograph of freeze-fractured cross section along the out-of-plane direction for silicone-CNT composites prepared with HDMS₀. Aggregates of CNTs appear as ‘white clusters’ due to CNT protrusion out of plane caused by pull-out during fracture.

FIG. 5B shows a representative SEM micrograph of freeze-fractured cross section along the out-of-plane direction for silicone-CNT composites prepared with HDMS36. Aggregates of CNTs appear as ‘white clusters’ due to CNT protrusion out of plane caused by pull-out during fracture.

FIG. 5C shows a representative SEM micrograph of freeze-fractured cross section along the out-of-plane direction for silicone-CNT composites prepared with 2-Star [DMS]₁₂. Aggregates of CNTs appear as ‘white clusters’ due to CNT protrusion out of plane caused by pull-out during fracture.

FIG. 6 shows a representative graph of PEO-SA siloxane:PEO ratio versus σDC [top] and corresponding PEO-SA loading concentration [bottom] of modified silicone-CNT composites.

FIG. 7 shows a representative graph of PEO-SA micelle diameter versus σDC of corresponding modified silicone-CNT composites.

FIG. 8A shows a representative graph of viscosity versus concentration of HDMS₀. Minima values are indicative of CMC transition occurring.

FIG. 8B shows a representative graph of viscosity versus concentration of HDMS₃₆. Minima values are indicative of CMC transition occurring.

FIG. 8C shows a representative graph of viscosity versus concentration of 2-Star [DMS]₁₂. Minima values are indicative of CMC transition occurring.

FIG. 9 shows a representative graph of compressive moduli of unmodified silicone (Sylgard 184*) [black striped bar], unmodified silicone loaded with CNTs (Sylgard 184) [black solid bar], and silicones modified with CNTs and PEO-SAs. * p<0.05 versus unmodified Sylgard 184*.

FIG. 10 shows a diagrammatic scheme of the method for fabricating electrodes from unmodified and PEO-SA modified silicone-composites.

FIG. 11 shows a representative graph of skin-electrode impedance of electrodes at 10 kHz. * p<0.05 v. Ag/AgCl electrodes.

FIG. 12A shows a view of an image of electrodes on skin in a skin-impedance test being conducted.

FIG. 12B shows a view of an image of wires attached in a skin-impedance test being conducted.

FIG. 12C shows a view of a wrap applied in a skin-impedance test being conducted.

FIG. 12D shows an image of a full view of a skin-impedance test being conducted.

### DETAILED DESCRIPTION

Various embodiments of the invention are described herein as follows. In an illustrative aspect, an amphiphilic siloxane compound including a siloxane tether segment and a polymer segment is provided.

In one aspect, the amphiphilic siloxane is of the formula I

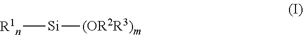

wherein R¹, R², R³, m, and n are as described herein.

In one aspect, the amphiphilic siloxane is of the amphiphilic siloxane compound is of the formula II

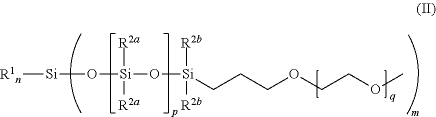

wherein R¹, R^{2a}, R^{2b}, m, n, p, and q are as described herein.

In one aspect, the amphiphilic siloxane is of the amphiphilic siloxane compound is of the formula III

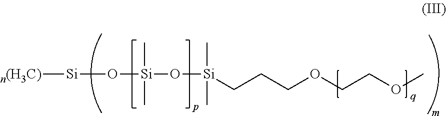

wherein m, n, p, and q are as described herein.

In one aspect, a mixture including an amphiphilic siloxane compound blended with a base polymer, and a filler is provided.

In one aspect, a method comprising formulating a paint comprising the amphiphilic siloxane compound is provided. In another aspect, a method comprising formulating a coating comprising the amphiphilic siloxane compound is provided.

In one aspect, a method comprising formulating a paint comprising the mixture is provided. In another aspect, a method comprising formulating a coating comprising the mixture is provided.

Unless otherwise defined herein, scientific and technical terms used in this application shall have the meanings that are commonly understood by those of ordinary skill in the art. Generally, nomenclature used in connection with, and techniques of, chemistry, cell and tissue culture, molecular biology, cell and cancer biology, neurobiology, neurochemistry, virology, immunology, microbiology, pharmacology, genetics and protein and nucleic acid chemistry, described herein, are those well known and commonly used in the art.

The methods and techniques of the present disclosure are generally performed, unless otherwise indicated, according to conventional methods well known in the art and as described in various general and more specific references that are cited and discussed throughout this specification.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, Calif. (1985).

All of the above, and any other publications, patents and published patent applications referred to in this application are specifically incorporated by reference herein. In case of conflict, the present specification, including its specific definitions, will control.

The term “amphiphilic” is intended to embrace a group or compound including two different affinities, such as a polar, hydrophilic, or water-soluble group and a nonpolar, hydrophobic, or water insoluble group.

The term “alkoxy” refers to an alkyl group having an oxygen attached thereto. Representative alkoxy groups include methoxy, ethoxy, propoxy, tert-butoxy and the like.

The term “alkyl” refers to saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

The term “alkyl” refers to a straight- or branched-chain monovalent hydrocarbon group. The term “alkylene” refers to a straight- or branched-chain divalent hydrocarbon group. In some embodiments, it can be advantageous to limit the number of atoms in an “alkyl” or “alkylene” to a specific range of atoms, such as C₁-C₂₀ alkyl or C₁-C₂₀ alkylene, C₁-C₁₀ alkyl or C₁-C₁₀ alkylene, or C₁-C₆ alkyl or C₁-C₆ alkylene. In preferred embodiments, a straight chain or branched chain alkyl has 10 or fewer carbon atoms in its backbone (e.g., C₁₋₁₀ for straight chains, C₃₋₁₀ for branched chains), and more preferably 6 or fewer. Examples of alkyl groups include methyl (Me), ethyl (Et), n-propyl, isopropyl, butyl, isobutyl, sec-butyl, tert-butyl (tBu), pentyl, isopentyl, tert-pentyl, hexyl, isohexyl, and groups that in light of the ordinary skill in the art and the teachings provided herein would be considered equivalent to any one of the foregoing examples. Examples of alkylene groups include methylene (—CH₂—), ethylene ((—CH₂—)₂), n-propylene ((—CH₂—)₃), iso-propylene ((—C(H)(CH₃)CH₂—)), n-butylene ((—CH₂—)₄), and the like. It will be appreciated that an alkyl or alkylene group can be unsubstituted or substituted as described herein. An alkyl or alkylene group can be substituted with any of the substituents in the various embodiments described herein, including one or more of such substituents.

The term “alkenyl” refers to a straight- or branched-chain mono-valent hydrocarbon group having one or more double bonds. The term “alkenylene” refers to a straight- or branched-chain di-valent hydrocarbon group having one or more double bonds. In some embodiments, it can be advantageous to limit the number of atoms in an “alkenyl” or “alkenylene” to a specific range of atoms, such as C₂-C₂₀ alkenyl or C₂-C₂₀ alkenylene, C₂-C₁₂ alkenyl or C₂-C₁₂ alkenylene, or C₂-C₆ alkenyl or C₂-C₆ alkenylene. In preferred embodiments, alkenyl groups include ethenyl (or vinyl) or allyl. Examples of alkenylene groups include ethenylene (or vinylene) (—CH═CH—), n-propenylene (—CH═CHCH₂—), iso-propenylene (—CH═CH(CH₃)—), and the like.

The term “alkynyl” refers to a straight- or branched-chain monovalent hydrocarbon group having one or more triple bonds. The term “alkynylene” refers to a straight- or branched-chain divalent hydrocarbon group having one or more triple bonds. In some embodiments, it can be advantageous to limit the number of atoms in an “alkynyl” or “alkynylene” to a specific range of atoms, such as C₂-C₂₀ alkynyl or C₂-C₂₀ alkynylene, C₂-C₁₂ alkynyl or C₂-C₁₂ alkynylene, or C₂-C₆ alkynyl or C₂-C₆ alkynylene. Examples of alkynyl groups include acetylenyl (—C≡CH) and propargyl (—CH₂C≡CH), but-3-yn-1,4-diyl (—C≡C—CH₂CH₂—), and the like. It will be appreciated that an alkynyl or alkynylene group can be unsubstituted or substituted as described herein. An alkynyl or alkynylene group can be substituted with any of the substituents in the various embodiments described herein, including one or more of such substituents.

Moreover, the terms “alkyl,” “alkenyl,” and “alkynyl” as used throughout the specification, examples, and claims is intended to include both unsubstituted and substituted alkyl, alkenyl, and alkynyl groups, the latter of which refers to moieties having substituents replacing a hydrogen on one or more carbons of the hydrocarbon backbone.

The term “C_{x-y}” or “Cₓ-C_{y}”, when used in conjunction with a chemical moiety, such as alkyl, is meant to include groups that contain from x to y carbons in the chain. C₀ alkyl indicates a hydrogen where the group is in a terminal position, a bond if internal. A C₁-C₆ alkyl group, for example, contains from one to six carbon atoms in the chain.

The term “acyl” refers to a group represented by the general formula hydrocarbylC(O)—, preferably alkylC(O)—.

The term “acrylate” refers to a group represented by the general formula CH₂=CHCO₂⁻, and is meant to include the salts, esters, and conjugate bases of acrylic acid. The term “methacrylate” refers to a group represented by the general formula CH₂=C(CH₃)CO₂⁻, and is meant to include the salts, esters, and conjugate bases of methacrylic acid.

The term “amide”, as used herein, refers to a group

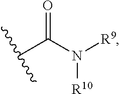

wherein R⁹ and R¹⁰ each independently represent a hydrogen or hydrocarbyl group, or R⁹ and R¹⁰ taken together with the N atom to which they are attached complete a heterocycle having from 4 to 8 atoms in the ring structure.

The term “aryl” as used herein include substituted or unsubstituted single-ring aromatic groups in which each atom of the ring is carbon. Preferably the ring is a 5- to 7-membered ring, more preferably a 6-membered ring. The term “aryl” also includes polycyclic ring systems having two or more cyclic rings in which two or more carbons are common to two adjoining rings wherein at least one of the rings is aromatic, e.g., the other cyclic rings can be cycloalkyls, cycloalkenyls, cycloalkynyls, aryls, heteroaryls, and/or heterocyclyls. Aryl groups include benzene, naphthalene, phenanthrene, phenol, aniline, and the like.

The terms “carboxy” and “carboxylic acid”, as used herein, refer to a group represented by the formula —CO₂H.

The term “crosslinking” refers to the formation of a bond or a short sequence of bonds that attach one functional group to another. Examples of crosslinking include, but are not limited to, the formation of a bond between a silane and a silane of a different structure, a silane of the same structure, or a functionalized polymer. In some embodiments, crosslinking can include a two-step process including the hydrolysis of an alkoxy silane to a first silanol, and condensation with a second silanol to form a Si—O—Si linkage between the two compounds. In other embodiments, crosslinking can include the formation of a bond between a silane and an alkene. For example, crosslinking a silane including a Si—H bond may including forming a bond with a terminal alkene (e.g. allyl or vinyl) on a second compound through a metal catalyzed reaction. The resulting bond can be represented by the general formula Si—CH₂—CH₂.

The term “dispersant”, as used herein, refers to a substance that is added to a suspension (e.g. a base polymer) of solid or liquid particles (e.g. a filler) to improve the separation or dispersion of the particles and to prevent their settling or clumping. Examples of dispersants include, but are not limited to, surfactants, emulsifiers, and the like.

The term “ester”, as used herein, refers to a group —C(O)OR⁹ wherein R⁹ represents a hydrocarbyl group.

The term “ether”, as used herein, refers to a hydrocarbyl group linked through an oxygen to another hydrocarbyl group. Accordingly, an ether substituent of a hydrocarbyl group may be hydrocarbyl-O—. Ethers may be either symmetrical or unsymmetrical. Examples of ethers include, but are not limited to, heterocycle-O-heterocycle and aryl-O-heterocycle. Ethers include “alkoxyalkyl” groups, which may be represented by the general formula alkyl-O-alkyl.

The terms “halo” and “halogen” as used herein means halogen and includes chloro, fluoro, bromo, and iodo.

The terms “heteroaryl” and “hetaryl” include substituted or unsubstituted aromatic single ring structures, preferably 5- to 7-membered rings, more preferably 5- to 6-membered rings, whose ring structures include at least one heteroatom, preferably one to four heteroatoms, more preferably one or two heteroatoms. The terms “heteroaryl” and “hetaryl” also include polycyclic ring systems having two or more cyclic rings in which two or more carbons are common to two adjoining rings wherein at least one of the rings is heteroaromatic, e.g., the other cyclic rings can be cycloalkyls, cycloalkenyls, cycloalkynyls, aryls, heteroaryls, and/or heterocyclyls. Heteroaryl groups include, for example, pyrrole, furan, thiophene, imidazole, oxazole, thiazole, pyrazole, pyridine, pyrazine, pyridazine, and pyrimidine, and the like.

The term “heteroatom” as used herein means an atom of any element other than carbon or hydrogen. Preferred heteroatoms are nitrogen, oxygen, and sulfur.

The terms “heterocyclyl”, “heterocycle”, and “heterocyclic” refer to substituted or unsubstituted non-aromatic ring structures, preferably 3- to 10-membered rings, more preferably 3- to 7-membered rings, whose ring structures include at least one heteroatom, preferably one to four heteroatoms, more preferably one or two heteroatoms. Heterocyclyl groups include, for example, epoxide, piperidine, piperazine, pyrrolidine, morpholine, lactones, lactams, and the like. In preferred embodiments, a heterocyclyl group is epoxide.

The term “hydrocarbyl”, as used herein, refers to a group that is bonded through a carbon atom that does not have a ═O or ═S substituent, and typically has at least one carbon-hydrogen bond and a primarily carbon backbone, but may optionally include heteroatoms. Thus, groups like methyl, ethoxyethyl, 2-pyridyl, and even trifluoromethyl are considered to be hydrocarbyl for the purposes of this application, but substituents such as acetyl (which has a ═O substituent on the linking carbon) and ethoxy (which is linked through oxygen, not carbon) are not. Hydrocarbyl groups include, but are not limited to aryl, heteroaryl, carbocycle, heterocycle, alkyl, alkenyl, alkynyl, and combinations thereof.

The term “linker” is used herein to refer to an atom or a collection of atoms optionally used to link interconnecting moieties such as a terminus of a polymer segment and a siloxane tether segment. The linker moieties of the invention may be hydrolytically stable or may include a physiologically hydrolyzable or enzymatically degradable linkage. In some embodiments, it can be advantageous to limit the number of atoms in a “linker” to a specific range of atoms, such as C₁-C₆ alkyl or C₁-C₆ alkylene, C₂-C₆ alkenyl or C₂-C₆ alkenylene, or C₂-C₆ alkynyl or C₂-C₆ alkynylene.

A “physiologically cleavable” or “hydrolyzable” or “degradable” bond is a relatively weak bond that reacts with water (i.e., is hydrolyzed) under physiological conditions. The tendency of a bond to hydrolyze in water will depend not only on the general type of linkage connecting two central atoms but also on the substituents attached to these central atoms. Appropriate hydrolytically unstable or weak linkages include, but are not limited to, carboxylate ester, phosphate ester, anhydrides, acetals, ketals, acyloxyalkyl ether, imines, orthoesters, and oligonucleotides.

An “enzymatically degradable linkage” means a linkage that is subject to degradation by one or more enzymes.

A “hydrolytically stable” linkage or bond refers to a chemical bond, typically a covalent bond, that is substantially stable in water, that is to say, does not undergo hydrolysis under physiological conditions to any appreciable extent over an extended period of time. Examples of hydrolytically stable linkages include but are not limited to the following: carbon-carbon bonds (e.g., in aliphatic chains), ethers, amides, urethanes, and the like. Generally, a hydrolytically stable linkage is one that exhibits a rate of hydrolysis of less than about 1-2% per day under physiological conditions. Hydrolysis rates of representative chemical bonds are known in the art.

The terms “PEG,” “polyethylene glycol” and “poly(ethylene glycol)” are used herein to mean any water-soluble poly(ethylene oxide) or PEO. For example, PEGs for use in the present invention will comprise one of the two following structures: “—O(CH₂CH₂O)_{q}—” or “—CH₂CH₂O(CH₂CH₂O)_{q}CH₂CH₂—,” where q is 3 to 24, and the terminal groups and architecture of the overall PEG may vary. “PEG” means a polymer that contains a majority, that is to say, greater than 50%, of subunits that are —CH₂CH₂O—.

One commonly employed PEG is end-capped PEG. When PEG is defined as “—O(CH₂CH₂O)ₙ—,” the end-capping group is generally a carbon-containing group typically comprised of 1-20 carbons and is preferably alkyl (e.g., methyl, ethyl or benzyl), although saturated and unsaturated forms thereof, as well as aryl, heteroaryl, cyclo, heterocyclo, and substituted forms of any of the foregoing are also envisioned. In preferred embodiments, PEG is end-capped with a methyl group.

The term “silane”, as used herein, refers to a silicon atom having a hydrogen atom or carbon atom attached thereto. The term “hydrosilane” refers to a group containing a Si—H group.

The term “silanol”, as used herein, refers to a silicon atom having a hydroxy group attached thereto. A silanol group may be represented by the general formula Si—OH.

The term “siloxane”, as used herein, refers to a group or a compound containing a silicon atom having two oxygen atoms attached thereto and/or an oxygen atom having two silicon atoms attached thereto, illustrated by the structures O—Si—O and Si—O—Si. As used herein, the term “siloxane” is contemplated to include a group or a compound containing alternating silicon and oxygen atoms in either a linear or cyclic arrangement. In some embodiments, siloxanes may contain two or more Si—O bonds with one or two additional groups attached to each silicon atom. A group attached to a silicon atom of a siloxane, for example, may be referred to as a pendant group (e. g., R^{2a}, R^{2b}). In some embodiments, a siloxane may have the formula

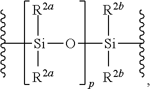

wherein p is an average number of repeat units of 3 to 40.

Furthermore, certain compounds which contain alkenyl groups may exist as Z (zusammen) or E (entgegen) isomers. In each instance, the disclosure includes both mixture and separate individual isomers.

As used herein, the term “optionally substituted” refers to the replacement of one to six hydrogen radicals in a given structure with the radical of a specified substituent including, but not limited to: halogen, hydroxyl, hydroxyalkyl, alkoxy, alkyl, nitro, silyl, acyl, acyloxy, aryl, cycloalkyl, heterocyclyl, amino, aminoalkyl, cyano, haloalkyl, haloalkoxy, or polyether. Preferably, “optionally substituted” refers to the replacement of one to four hydrogen radicals in a given structure with the substituents mentioned above. More preferably, one to three hydrogen radicals are replaced by the substituents as mentioned above. It is understood that the substituent can be further substituted.

To provide a more concise description, some of the quantitative expressions given herein are not qualified with the term “about.” It is understood that, whether the term “about” is used explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. Whenever a yield is given as a percentage, such yield refers to a mass of the entity for which the yield is given with respect to the maximum amount of the same entity that could be obtained under the particular stoichiometric conditions. Concentrations that are given as percentages refer to mass ratios, unless indicated differently.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

Except as otherwise noted, the methods and techniques of the present embodiments are generally performed according to conventional methods well known in the art and as described in various general and more specific references that are cited and discussed throughout the present specification. See, e.g., Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

Chemical nomenclature for compounds described herein has generally been derived using the commercially-available ACD/Name 2014 (ACD/Labs) or ChemBioDraw Ultra 13.0 (Perkin Elmer).

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination. All combinations of the embodiments pertaining to the chemical groups represented by the variables are specifically embraced by the present disclosure and are disclosed herein just as if each and every combination was individually and explicitly disclosed, to the extent that such combinations embrace compounds that are stable compounds (i.e., compounds that can be isolated, characterized, and tested for biological activity). In addition, all subcombinations of the chemical groups listed in the embodiments describing such variables are also specifically embraced by the present disclosure and are disclosed herein just as if each and every such sub-combination of chemical groups was individually and explicitly disclosed herein.

In some embodiments, the disclosure provides an amphiphilic siloxane compound comprising a siloxane tether segment and a polymer segment. In some embodiments, the amphiphilic siloxane compound is a dispersant. In some embodiments, the amphiphilic siloxane compound comprises a linear orientation. In some embodiments, the amphiphilic siloxane compound comprises a branched orientation.

In some embodiments, the disclosure provides an amphiphilic siloxane compound of the formula I

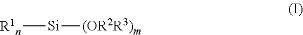

wherein each R¹, when present, is independently selected from the group consisting of hydrogen, alkyl, phenyl, vinyl, allyl, alkoxy, acrylate, methacrylate, amine, carboxylic acid, epoxide, and R³; R² is the siloxane tether segment; R³ is the polymer segment; n is an integer of 0, 1, 2, or 3; m is an integer of 1, 2, 3, or 4; and n+m=4.

In some embodiments, the disclosure provides an amphiphilic siloxane compound of the formula II

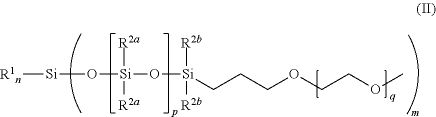

wherein each R¹, when present, is independently selected from the group consisting of hydrogen, alkyl, phenyl, vinyl, allyl, alkoxy, acrylate, methacrylate, amine, carboxylic acid, epoxide, and R³; each R^{2a} and R^{2b} is independently selected from the group consisting of hydrogen, halo, alkyl, haloalkyl, alkoxy, haloalkoxy, aryl, aryl, and heteroaryl; R³, when present, is

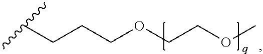

wherein p is an average number of repeat units of 3 to 40; each q is an average number of repeat units of 3 to 24; n is an integer of 0, 1, 2, or 3; m is an integer of 1, 2, 3, or 4; and n+m=4.

In some embodiments, the disclosure provides an amphiphilic siloxane compound of the formula III

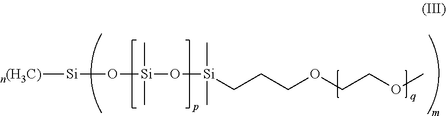

wherein p is an average number of repeat units of 3 to 40; each q is an average number of repeat units of 3 to 24; n is an integer of 0, 1, 2, or 3; m is an integer of 1, 2, 3, or 4; and n+m=4.

In some embodiments, each R¹, when present, is independently selected from the group consisting of hydrogen, alkyl, phenyl, vinyl, allyl, alkoxy, acrylate, methacrylate, amine, carboxylic acid, epoxide, and R³. In some embodiments, each R¹, when present, is independently selected from H, alkyl, or R³. In some embodiments, each R¹, when present, is independently selected from H, C₁-C₆ alkyl (e.g. methyl, ethyl, propyl), or R³. In some embodiments, R¹ is H. In some embodiments, R¹ is alkyl. In some embodiments, R¹ is C₁-C₆ alkyl (e.g. methyl, ethyl, propyl). In preferred embodiments, R¹ is C₁-C₆ alkyl, optionally substituted by a poly(alkylene oxide) (e.g. poly(ethylene oxide)). In some embodiments, R¹ is unsubstituted methyl. In some embodiments, R¹ is propyl, optionally substituted by a poly(alkylene oxide) (e.g. poly(ethylene oxide)). In some embodiments, R¹ is R³. In some embodiments, R¹ is

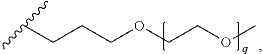

wherein q is an average number of repeat units of 3 to 24. In some embodiments, R¹ is

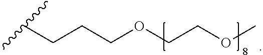

In some embodiments, R² is the siloxane tether segment. In some embodiments, the siloxane tether segment (R²) comprises a backbone of one or more siloxane (Si—O) unit. In some embodiments, the backbone of the siloxane tether segment (R²) comprises a one or more pendant group (e. g., R^{2a}, R^{2b}) bound to a silicon atom of the backbone. In some embodiments, the siloxane tether segment (R²) is of the formula

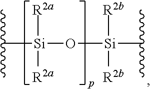

wherein each R^{2a} and R^{2b} is independently selected from the group consisting of hydrogen, halo, alkyl, haloalkyl, alkoxy, haloalkoxy, aryl, and heteroaryl; and p is an average number of repeat units of 3 to 40. In preferred embodiments, the siloxane tether segment (R²) is of the formula

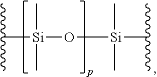

wherein p is an average number of repeat units of 3 to 40. In some embodiments, the siloxane tether segment (R²) covalently bound to a polymer segment (R³).

In some embodiments, each p is an average number of repeat units of 3 to 40. In some embodiments, p is 3 to 36. In some embodiments, p is 3, 4, 6, 12, 13, 16, 24, or 36. In preferred embodiments, p is 12.

In some embodiments, each R^{2a} and R^{2b} is independently selected from the group consisting of hydrogen, halo, alkyl, haloalkyl, alkoxy, haloalkoxy, aryl, and heteroaryl. In some embodiments, each R^{2a} and R^{2b} is independently H or alkyl. In some embodiments, each R^{2a} and R^{2b} is independently H or C₁-C₆ alkyl (e.g. methyl). In some embodiments, each R², and R^{2b} is independently H. In some embodiments, each R^{2a} and R^{2b} is independently C₁-C₆ alkyl (e.g. methyl). In preferred embodiments, each R^{2a} and R^{2b} is methyl.

In some embodiments, R³ is the polymer segment. In some embodiments, the polymer segment (R³) comprises a poly(alkylene oxide), polyoxazolines (POx), a poly(vinyl alcohol) (PVA), a poly(N-vinyl pyrrolidinone) (PVP), a poly(glutamic acid) (PGA), a polyacrylamide (PAM), a poly(N-isopropylacrylamide) (PNIPAAm), a polyethyleneimine (PEI), a poly(2-hydroxy ethyl methacrylate) (PHEMA), a alginate, a poly(2-methacryloyloxyethyl phosphorylcholine) (PMPC), a polylysine, polycarboyxbetaine, and any combination thereof. In preferred embodiments, the polymer segment (R³) comprises a poly(alkylene oxide) (e. g. poly(ethylene glycol) (PEG)).

In some embodiments, the polymer segment (R³) further comprises a linker (L). In some embodiments, the polymer segment (R³) is of the formula

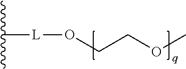

wherein L is a linker selected from alkylene, alkenylene, or alkynylene; and q is an average number of repeat units of 3 to 24. In some embodiments, the linker (L) is C₁-C₆ alkylene, C₂-C₆ alkenylene, or C₂-C₆ alkynylene. In preferred embodiments, the linker (L) is C₁-C₆ alkylene (e. g., propylene). In some embodiments, the polymer segment (R³) is

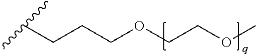

wherein q is an average number of repeat units of 3 to 24. In preferred embodiments, the polymer segment (R³) is

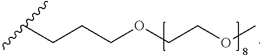

In some embodiments, each q is an average number of repeat units of 3 to 24. In some embodiments, each q is 3 to 20. In some embodiments, each q is 3 to 16. In some embodiments, each q is 5 to 16. In some embodiments, each q is 8 or 16. In preferred embodiments, each q is 8.

In some embodiments, n is an integer of 0, 1, 2, or 3. In some embodiments, n is an integer of 1, 2, or 3. In some embodiments, n is an integer of 2 or 3. In some embodiments, n is an integer of 2. In some embodiments, n is an integer of 3.

In some embodiments, m is an integer of 1, 2, 3, or 4. In some embodiments, m is an integer of 1, 2, or 3. In some embodiments, m is an integer of 1 or 2. In some embodiments, m is an integer of 1. In some embodiments, m is an integer of 2.

In some embodiments, n+m=4. In preferred embodiments, n is 3 and m is 1.

In some embodiments, n is 3, and two of R¹ are each methyl. In some embodiments, n is 3, two of R¹ are each methyl, and the third of R¹ is H. In some embodiments, n is 3, two of R¹ are each methyl, and the third of R¹ is R³. In some embodiments, n is 3, and three of R¹ are each methyl.

In some embodiments, n is 2. In some embodiments, n is 2, and two of R¹ are each methyl. In some embodiments, n is 1. In some embodiments, n is 1, and R¹ is methyl. In some embodiments, n is 0.

In some embodiments, the amphiphilic siloxane compound is selected from

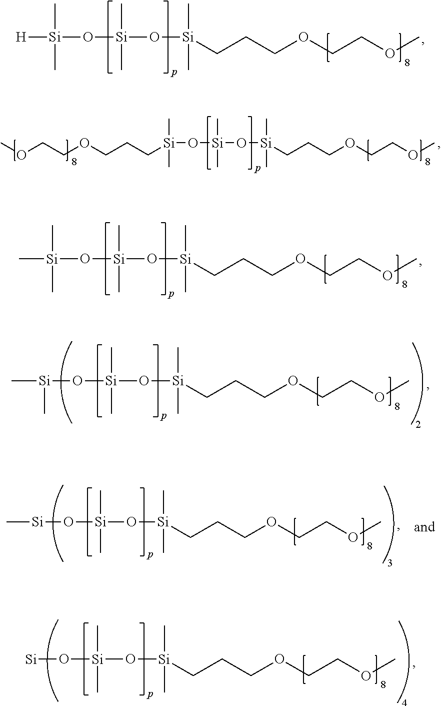

wherein p is an average number of repeat units of 3 to 36.

In some embodiments, the amphiphilic siloxane compound is selected from

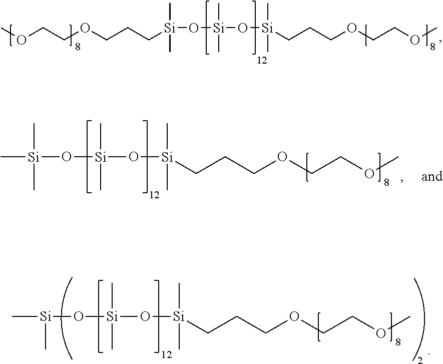

In some embodiments, a mixture includes the amphiphilic siloxane compound blended with a base polymer, and a filler.

In some embodiments, the amphiphilic siloxane compound is covalently crosslinked with the base polymer. In some embodiments, the amphiphilic siloxane compound is covalently crosslinked with a surface to provide a coating of the surface.

In some embodiments, the surface is selected from blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ophthalmic device, and any combination thereof. In some embodiments, the surface is selected from ship hulls, submerges structures, and any combination thereof. In some embodiments, the surface is selected from glass, metal, metal oxide, polymer, composite, and any combination thereof.

In some embodiments, the base polymer is selected from the group of an acrylic, an alkyd, an epoxy, a polyurethane, an acrylic aliphatic urethane, a polyurea, a silicone, a natural or synthetic rubber, a nylon, a nitrocellulose, a polyamide, a polycarbonate, a polyethylene, a polypropylene, a polyester, a polyvinyl chloride, a phenolic, a latex, and any combination thereof. In preferred embodiments, the base polymer is silicone.

In some embodiments, the filler is selected from the group of a carbon nanotube, graphite, graphene, carbon black, a metal filler, a ceramic filler, a metal-coated filler, Teflon, a pigment, and any combination thereof. In preferred embodiments, the filler is a carbon nanotube. In some embodiments, the carbon nanotube is single-walled. In some embodiments, the carbon nanotube is double-walled.

In some embodiments, the filler is a pigment. In some embodiments, the pigment is selected from titanium dioxide, zinc oxide, zinc sulfide, lithopone, barium sulfate, copper phthalocyanine-based, quinacridone, iron oxide, iron oxide, dirarylide, perinone, talc, calcium carbonate, limestone, silica, sand, mica, clay, barite, aluminum flake pigment, a pearlescent pigment, a fluorescent pigment, a metallic pigment, zinc chromate (ZnCrO₄), antimony oxide (Sb₂O₃), and any combination thereof.

In some embodiments, the mixture does not comprise a solvent. In some embodiments, the mixture is substantially free from solvent.

In some embodiments, the mixture further comprises a solvent. In some embodiments, the solvent is selected from xylene, toluene, water, mineral spirits, methyl ethyl ketone, n-butyl acetate, t-butyl alcohol, ethylene glycol, water, and any combination thereof.

In some embodiments, the mixture further comprises an additive. In some embodiments, the additive is selected from a rheological-control additive, a catalyst, a drier, a wetting agent, a defoamer, a fungicide, a bactericide, and any combination thereof.

In some embodiments, the mixture is applied to a structure or a material. In some embodiments, the structure or material is selected from blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ophthalmic device, and any combination thereof. In some embodiments, the structure or material is selected from ship hulls, submerged structures, transportation vehicle, aircraft, and combinations thereof. In some embodiments, the structure or material is selected from glass, metal, metal oxide, polymer, polymer composites, and any combination thereof. In some embodiments, the mixture is used in the formation of a structure or a material.

In some embodiments, a method comprising formulating a coating comprising the amphiphilic siloxane compound is provided. In some embodiments, a method comprising formulating a coating comprising the mixture is provided.

In some embodiments, a method comprising formulating a paint comprising the amphiphilic siloxane compound is provided. In some embodiments, a method comprising formulating a paint comprising the mixture is provided.

In some embodiments, the method further includes applying the paint to a structure or a material. In some embodiments, the method further includes applying the coating to a structure or a material. In some embodiments, the coating is a paint.

In some embodiments, the method further includes dispersing the filler in the base polymer. In some embodiments, the method further includes crosslinking the amphiphilic siloxane compound. In some embodiments, the method further includes covalent crosslinking the amphiphilic siloxane compound with the base polymer. In some embodiments, the method further includes covalent crosslinking with a surface to provide a coating of the surface.

The following numbered embodiments are contemplated and are non-limiting:

1. An amphiphilic siloxane compound comprising:
a siloxane tether segment; and a polymer segment;
wherein the amphiphilic siloxane compound is of the formula I

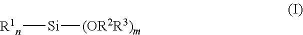

wherein
each R¹, when present, is independently selected from the group consisting of hydrogen, alkyl, phenyl, vinyl, allyl, alkoxy, acrylate, methacrylate, amine, carboxylic acid, epoxide, and R³;
R² is the siloxane tether segment;
R³ is the polymer segment;
n is an integer of 0, 1, 2, or 3; m is an integer of 1, 2, 3, or 4; and n+m=4.

2. The amphiphilic siloxane compound of clause 1, any other suitable clause, or any combination of suitable clauses, wherein the polymer segment (R³) comprises a poly(alkylene oxide), polyoxazolines (POx), a poly(vinyl alcohol) (PVA), a poly(N-vinyl pyrrolidinone) (PVP), a poly(glutamic acid) (PGA), a polyacrylamide (PAM), a poly(N-isopropylacrylamide) (PNIPAAm), a polyethyleneimine (PEI), a poly(2-hydroxy ethyl methacrylate) (PHEMA), a alginate, a poly(2-methacryloyloxyethyl phosphorylcholine) (PMPC), a polylysine, polycarboyxbetaine, and any combination thereof.

3. The amphiphilic siloxane compound of clause 2, any other suitable clause, or any combination of suitable clauses, wherein the polymer segment (R³) comprises a poly(alkylene oxide) (e. g. poly(ethylene glycol) (PEG)).

4. The amphiphilic siloxane compound of clause 1, any other suitable clause, or any combination of suitable clauses, wherein the polymer segment (R³) further comprises a linker (L).

5. The amphiphilic siloxane compound of clause 1, any other suitable clause, or any combination of suitable clauses, wherein the polymer segment (R³) is of the formula

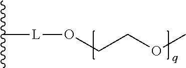

wherein
   L is a linker selected from alkylene, alkenylene, or alkynylene; and
   q is an average number of repeat units of 3 to 24.

6. The amphiphilic siloxane compound of clause 4, any other suitable clause, or any combination of suitable clauses, wherein the linker (L) is C₁-C₆ alkylene, C₂-C₆ alkenylene, or C₂-C₆ alkynylene.

7. The amphiphilic siloxane compound of clause 4, any other suitable clause, or any combination of suitable clauses, wherein the linker (L) is C₁-C₆ alkylene (e. g., propylene).

8. The amphiphilic siloxane compound of clause 5, any other suitable clause, or any combination of suitable clauses, wherein the polymer segment (R³) is

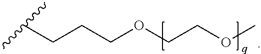

9. The amphiphilic siloxane compound of clause 1, any other suitable clause, or any combination of suitable clauses, wherein each R¹ is independently H, C₁-C₆ alkyl, or R³.

10. The amphiphilic siloxane compound of clause 9, any other suitable clause, or any combination of suitable clauses, wherein R¹ is H.

11. The amphiphilic siloxane compound of clause 9, any other suitable clause, or any combination of suitable clauses, wherein R¹ is C₁-C₆ alkyl, optionally substituted by a poly(alkylene oxide).

12. The amphiphilic siloxane compound of clause 11, any other suitable clause, or any combination of suitable clauses, wherein R¹ is methyl, ethyl, or propyl, optionally substituted by a poly(alkylene oxide).

13. The amphiphilic siloxane compound of clause 11, any other suitable clause, or any combination of suitable clauses, wherein R¹ is unsubstituted methyl.

14. The amphiphilic siloxane compound of clause 11, any other suitable clause, or any combination of suitable clauses, wherein R¹ is propyl, substituted by a poly(alkylene oxide).

15. The amphiphilic siloxane compound of clause 5, any other suitable clause, or any combination of suitable clauses, wherein R¹ is R³, and each q is an average number of repeat units of 3 to 24.

16. The amphiphilic siloxane compound of clause 15, any other suitable clause, or any combination of suitable clauses, wherein each q is 3 to 20.

17. The amphiphilic siloxane compound of clause 16, any other suitable clause, or any combination of suitable clauses, wherein each q is 3 to 16.

18. The amphiphilic siloxane compound of clause 16, any other suitable clause, or any combination of suitable clauses, wherein each q is 5 to 16.

19. The amphiphilic siloxane compound of clause 16, any other suitable clause, or any combination of suitable clauses, wherein each q is 8 or 16.

20. The amphiphilic siloxane compound of clause 16, any other suitable clause, or any combination of suitable clauses, wherein each q is 8.

21. The amphiphilic siloxane compound of clause 1, any other suitable clause, or any combination of suitable clauses, wherein the polymer segment is bound to the siloxane tether segment.

22. The amphiphilic siloxane compound of clause 1, any other suitable clause, or any combination of suitable clauses, wherein the siloxane tether segment comprises a backbone of one or more siloxane (Si—O) unit.

23. The amphiphilic siloxane compound of clause 22, any other suitable clause, or any combination of suitable clauses, wherein the backbone comprises a one or more pendant group (e. g., R^{2a}, R^{2b}) bound to a silicon atom of the backbone.

24. The amphiphilic siloxane compound of clause 23, any other suitable clause, or any combination of suitable clauses, wherein the one or more pendant group (e. g., R^{2a}, R^{2b}) is selected from the group consisting of hydrogen, halo, alkyl, haloalkyl, alkoxy, haloalkoxy, aryl, heteroaryl, and any combination thereof.

25. The amphiphilic siloxane compound of clause 1, any other suitable clause, or any combination of suitable clauses, wherein the siloxane tether segment is of the formula

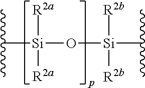

wherein
   each R^{2a} and R^{2b} is independently selected from the group consisting of hydrogen, halo, alkyl, haloalkyl, alkoxy, haloalkoxy, aryl, aryl, and heteroaryl; and
   p is an average number of repeat units of 3 to 40.

26. The amphiphilic siloxane compound of clause 25, any other suitable clause, or any combination of suitable clauses, wherein each R^{2a} and R^{2b} is independently H or C₁-C₆ alkyl.

27. The amphiphilic siloxane compound of clause 26, any other suitable clause, or any combination of suitable clauses, wherein each R^{2a} and R^{2b} is C₁-C₆ alkyl.

28. The amphiphilic siloxane compound of clause 27, any other suitable clause, or any combination of suitable clauses, wherein each R^{2a} and R^{2b} is methyl.

29. The amphiphilic siloxane compound of clause 25, any other suitable clause, or any combination of suitable clauses, wherein p is 3 to 36.

30. The amphiphilic siloxane compound of clause 29, any other suitable clause, or any combination of suitable clauses, wherein p is 3, 4, 6, 12, 13, 16, 24, or 36.

31. The amphiphilic siloxane compound of clause 30, any other suitable clause, or any combination of suitable clauses, wherein p is 12.

32. The amphiphilic siloxane compound of clause 1, any other suitable clause, or any combination of suitable clauses, wherein the amphiphilic siloxane compound is of the formula II

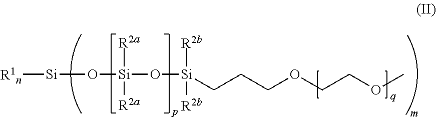

wherein
   each R¹, when present, is independently selected from the group consisting of hydrogen, alkyl, phenyl, vinyl, allyl, alkoxy, acrylate, methacrylate, amine, carboxylic acid, epoxide, and R³;
   each R^{2a} and R^{2b} is independently selected from the group consisting of hydrogen, halo, alkyl, haloalkyl, alkoxy, haloalkoxy, aryl, and heteroaryl;
   R³, when present, is

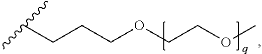

wherein
   p is an average number of repeat units of 3 to 40;
   each q is an average number of repeat units of 3 to 24.
   n is an integer of 0, 1, 2, or 3; m is an integer of 1, 2, 3, or 4; and n+m=4.

33. The amphiphilic siloxane compound of clause 32, any other suitable clause, or any combination of suitable clauses, wherein n is 3.

34. The amphiphilic siloxane compound of clause 33, any other suitable clause, or any combination of suitable clauses, wherein n is 3, and two of R¹ are each methyl.

35. The amphiphilic siloxane compound of clause 33, any other suitable clause, or any combination of suitable clauses, wherein n is 3, two of R¹ are each methyl, and the third of R¹ is H.

36. The amphiphilic siloxane compound of clause 33, any other suitable clause, or any combination of suitable clauses, wherein n is 3, two of R¹ are each methyl, and the third of R¹ is R³.

37. The amphiphilic siloxane compound of clause 33, any other suitable clause, or any combination of suitable clauses, wherein n is 3, and three of R¹ are each methyl.

38. The amphiphilic siloxane compound of clause 1, any other suitable clause, or any combination of suitable clauses, wherein the amphiphilic siloxane compound comprises a linear orientation.

39. The amphiphilic siloxane compound of clause 32, any other suitable clause, or any combination of suitable clauses, wherein n is 2.

40. The amphiphilic siloxane compound of clause 39, any other suitable clause, or any combination of suitable clauses, wherein n is 2, and two of R¹ are each methyl.

41. The amphiphilic siloxane compound of clause 1, any other suitable clause, or any combination of suitable clauses, wherein the amphiphilic siloxane compound comprises a branched orientation.

42. The amphiphilic siloxane compound of clause 32, any other suitable clause, or any combination of suitable clauses, wherein n is 1.

43. The amphiphilic siloxane compound of clause 42, any other suitable clause, or any combination of suitable clauses, wherein n is 1, and R¹ is methyl.

44. The amphiphilic siloxane compound of clause 32, any other suitable clause, or any combination of suitable clauses, wherein each R^{2a} and R^{2b} is methyl.

45. The amphiphilic siloxane compound of clause 32, any other suitable clause, or any combination of suitable clauses, wherein n is 0.

46. The amphiphilic siloxane compound of clause 1, selected from

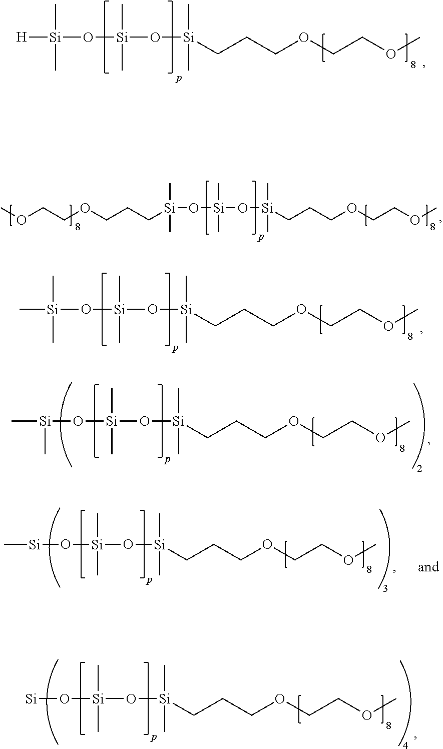

wherein p is an average number of repeat units of 3 to 36.

47. The amphiphilic siloxane compound of clause 46, selected from

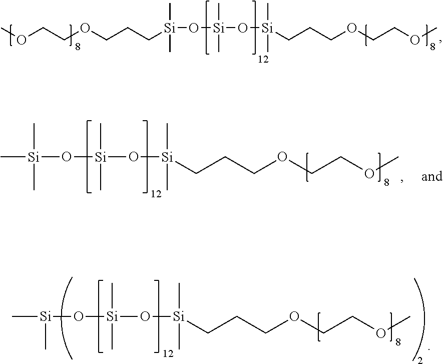

48. The amphiphilic siloxane compound of clause 1, any other suitable clause, or any combination of suitable clauses, wherein the amphiphilic siloxane compound is a dispersant.

49. A mixture comprising the amphiphilic siloxane compound according to clause 1, any other suitable clause, or any combination of suitable clauses, blended with a base polymer, and a filler.

50. The mixture of clause 49, any other suitable clause, or any combination of suitable clauses, wherein the amphiphilic siloxane compound is covalently crosslinked with the base polymer.

51. The mixture of clause 49, any other suitable clause, or any combination of suitable clauses, wherein the amphiphilic siloxane compound is covalently crosslinked with a surface to provide a coating of the surface.

52. The mixture of clause 51, any other suitable clause, or any combination of suitable clauses, wherein the surface is selected from blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ophthalmic device, and any combination thereof.

53. The mixture of clause 51, any other suitable clause, or any combination of suitable clauses, wherein the surface is selected from ship hulls, submerges structures, and any combination thereof.

54. The mixture of clause 51, any other suitable clause, or any combination of suitable clauses, wherein the surface is selected from glass, metal, metal oxide, polymer, composite, and any combination thereof.

55. The mixture of clause 49, any other suitable clause, or any combination of suitable clauses, wherein the base polymer is selected from the group of an acrylic, an alkyd, an epoxy, a polyurethane, an acrylic aliphatic urethane, a polyurea, a silicone, a natural or synthetic rubber, a nylon, a nitrocellulose, a polyamide, a polycarbonate, a polyethylene, a polypropylene, a polyester, a polyvinyl chloride, a phenolic, a latex, and any combination thereof.

56. The mixture of clause 55, any other suitable clause, or any combination of suitable clauses, wherein the base polymer is a silicone.

57. The mixture of clause 49, any other suitable clause, or any combination of suitable clauses, wherein the filler is selected from the group of a carbon nanotube, graphite, graphene, carbon black, a metal filler, a ceramic filler, a metal-coated filler, Teflon, a pigment, and any combination thereof.

58. The mixture of clause 57, any other suitable clause, or any combination of suitable clauses, wherein the filler is a carbon nanotube.

59. The mixture of clause 58, any other suitable clause, or any combination of suitable clauses, wherein the carbon nanotube is single-walled.

60. The mixture of clause 58, any other suitable clause, or any combination of suitable clauses, wherein the carbon nanotube is double-walled.

61. The mixture of clause 57, any other suitable clause, or any combination of suitable clauses, wherein the filler is a pigment.

62. The mixture of clause 61, any other suitable clause, or any combination of suitable clauses, wherein the pigment is selected from titanium dioxide, zinc oxide, zinc sulfide, lithopone, barium sulfate, copper phthalocyanine-based, quinacridone, iron oxide, iron oxide, dirarylide, perinone, talc, calcium carbonate, limestone, silica, sand, mica, clay, barite, aluminum flake pigment, a pearlescent pigment, a fluorescent pigment, a metallic pigment, zinc chromate (ZnCrO₄), antimony oxide (Sb₂O₃), and any combination thereof.

63. The mixture of clause 49, any other suitable clause, or any combination of suitable clauses, wherein the mixture does not comprise a solvent.

64. The mixture of clause 49, any other suitable clause, or any combination of suitable clauses, wherein the mixture further comprises a solvent.

65. The mixture of clause 64, any other suitable clause, or any combination of suitable clauses, wherein the solvent is selected from xylene, toluene, water, mineral spirits, methyl ethyl ketone, n-butyl acetate, t-butyl alcohol, ethylene glycol, water, and any combination thereof.

66. The mixture of clause 49, any other suitable clause, or any combination of suitable clauses, wherein the mixture further comprises an additive.

67. The mixture of clause 66, any other suitable clause, or any combination of suitable clauses, wherein the additive is selected from a rheological-control additive, a catalyst, a drier, a wetting agent, a defoamer, a fungicide, a bactericide, and any combination thereof.

68. The mixture of clause 49, any other suitable clause, or any combination of suitable clauses, wherein the mixture is applied to a structure or a material.

69. The mixture of clause 68, any other suitable clause, or any combination of suitable clauses, wherein the structure or material is selected from blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ophthalmic device, and any combination thereof.

70. The mixture of clause 68, any other suitable clause, or any combination of suitable clauses, wherein the structure or material is selected from ship hulls, submerged structures, transportation vehicle, aircraft, and combinations thereof.

71. The mixture of clause 68, any other suitable clause, or any combination of suitable clauses, wherein the structure or material is selected from glass, metal, metal oxide, polymer, polymer composites, and any combination thereof.

72. The mixture of clause 49, any other suitable clause, or any combination of suitable clauses, wherein the mixture is used in the formation of a structure or a material.

73. The mixture of clause 72, any other suitable clause, or any combination of suitable clauses, wherein the structure or material is selected from blood-contacting intracorporeal devices, blood-contacting extracorporeal devices, tissue-contacting intracorporeal devices, tissue-contacting extracorporeal devices, catheters, stents, mechanical heart components, heart leads, subcutaneously implanted sensors, blood oxygenator pumps, tubing, syringes, blood bags, ophthalmic device, and any combination thereof.

74. The mixture of clause 72, any other suitable clause, or any combination of suitable clauses, wherein the structure or material is selected from ship hulls, submerged structures, transportation vehicle, aircraft, and combinations thereof.

75. The mixture of clause 72, any other suitable clause, or any combination of suitable clauses, wherein the structure or material is selected from glass, metal, metal oxide, polymer, composite, and any combination thereof.

76. A method comprising formulating a paint comprising the mixture according to clause 49, any other suitable clause, or any combination of suitable clauses.

77. The method of clause 76, any other suitable clause, or any combination of suitable clauses, wherein the paint is applied to a structure or a material.

78. A method comprising formulating a coating comprising the mixture according to clause 49, any other suitable clause, or any combination of suitable clauses.

79. The method of clause 79, any other suitable clause, or any combination of suitable clauses, wherein the coating is a paint.

80. The method of clause 79, any other suitable clause, or any combination of suitable clauses, wherein the coating is applied to a structure or a material.

81. A method comprising formulating a paint comprising the amphiphilic siloxane compound according to clause 1, any other suitable clause, or any combination of suitable clauses.

82. The method of clause 81, any other suitable clause, or any combination of suitable clauses, wherein the paint is applied to a structure or a material.

83. A method comprising formulating a coating comprising the amphiphilic siloxane compound according to clause 1, any other suitable clause, or any combination of suitable clauses.

84. The method of clause 83, any other suitable clause, or any combination of suitable clauses, wherein the coating is a paint.

85. The method of clause 83, any other suitable clause, or any combination of suitable clauses, wherein the coating is applied to a structure or a material.

The use of the term “or” in the claims or clauses herein is used to mean “and/or” unless explicitly indicated to refer to alternatives only or the alternatives are mutually exclusive, although the disclosure supports a definition that refers to only alternatives and “and/or.”

As used herein and in the appended clauses, the singular forms “a,” “an,” and “the” include plural referents unless the context clearly dictates otherwise. Thus, for example, reference to a “polymer” includes a single polymer as well as two or more of the same or different polymers. It is also to be understood that reference to a “polymer” used herein is for describing a single polymer, a combination of polymers, or a blend of polymers.

It is further noted that the clauses may be drafted to exclude any optional element. As such, this statement is intended to serve as antecedent basis for use of such exclusive terminology as “solely,” “only” and the like in connection with the recitation of clause elements, or use of a “negative” limitation.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “optional” or “optionally” mean that the subsequently described event or circumstance may occur or may not occur, and that the description includes instances where the event or circumstance occurs as well as instances in which it does not. For example, “optionally substituted alkyl” refers to the alkyl may be substituted as well as where the alkyl is not substituted.

### EXAMPLES

The examples and preparations provided below further illustrate and exemplify particular aspects of embodiments of the disclosure. It is to be understood that the scope of the present disclosure is not limited in any way by the scope of the following examples.

### Example 1

### Exemplary Experimental Procedures

The instant example provides exemplary materials and methods utilized in Examples 2-7 as described herein.

Materials. Allyl methyl PEO (“A-PEO₈-M”) (UNIOX-PKA 5008, Mₙ=450 g mol⁻¹ per manufacturer's specifications; Mₙ=450 g mol⁻¹ per ¹H NMR end group analysis; ¹H NMR (400 MHz; CDCl₃; δ, ppm): 3.37 (s, 3H, OCH₃), 3.53-3.65 (m, 34H, OCH₂CH₂), 4.00 (d, J=5.4 Hz, 2H, CH₂=CHCH₂O), 5.14-5.29 (m, 2H, CH₂=CHCH₂O), and 5.84-5.96 (m, 1H, CH₂=CHCH₂O)] was provided by NOF Corporation. Pentamethyldisiloxane (PMDS), 1,1,3,3,5,5-hexamethyltrisiloxane (HMTS), methyltris(dimethylsiloxy)silane (MTDS), tetrakis-(dimethylsiloxy)silane (TKDS), 1,1,3,3-tetramethyldisiloxane (TMDS), and octamethylcyclotetrasiloxane (D₄) were purchased from Gelest. Tris(triphenyl-phosphine)rhodium(I) chloride (Wilkinson's catalyst), platinum (Pt)-divinyltetramethyldisiloxane complex (Karstedt's catalyst) in xylene, hexamethyldisilazane, triflic acid, and CNTs [multiwalled, 98% carbon basis, O.D.: 6-13 nm, L: 2.5-20 μm, per manufacturer's specifications] and solvents were purchased from Millipore Sigma. Solvents were dried in 4 Å molecular sieves prior to use in reactions. Sylgard 184 was purchased from Dow Corning. Per manufacturer's specifications, the Sylgard 184 base (“Part A”) is composed of dimethylvinyl-terminated dimethylsiloxane (>60 wt %), tetra (trimethylsiloxy) silane (1.0-5.0 wt %), and dimethylvinylated as well as trimethylated silica (30-60 wt %). The Sylgard 184 curing agent (“Part B”) is composed of dimethyl, methylhydrogen siloxane (40-70 wt %), dimethylvinyl-terminated dimethylsiloxane (>15-40 wt %), tetramethyl tetravinyl cyclotetrasiloxane (1.0-5.0 wt %) and dimethylvinylated as well as trimethylated silica (10-30 wt %). Ag/AgCl snap buttons (model #: 5-9002/300/0.075) were purchased from Select Engineering Inc.

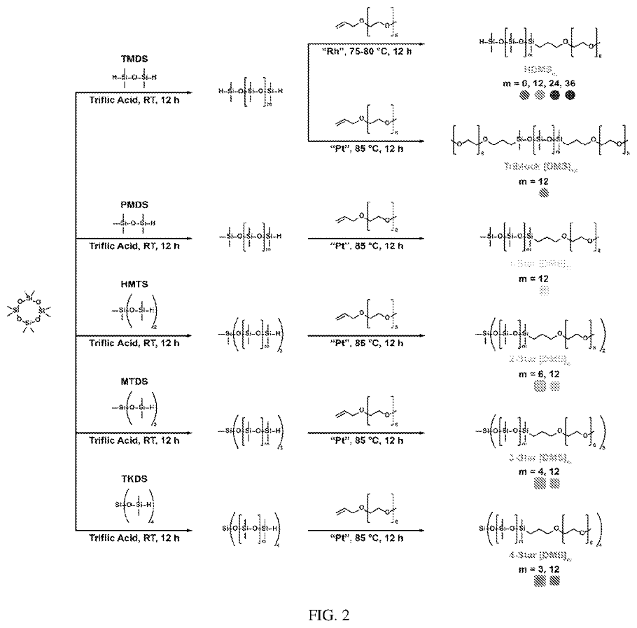

General Synthetic Approach. All reactions took place under N₂ with a Teflon-coated stir bar. Chemical structures of intermediates and final 12 amphiphilic PEO-SA DPSAs (FIG. 2) were confirmed via ¹H NMR spectroscopy using a Bruker Avance Neo 400 MHz spectrometer with an Ascend magnet, an automated tuning 5 mm broadband iProbe, operating in Fourier transform mode and with CDCl₃ as the standard.

Abbreviations: The examples described herein use materials, including but not limited to, those described by the following abbreviations known to those skilled in the art:

| | |
|---|---|
| g | grams |
| eq | equivalents |
| mmol | millimoles |
| mL | milliliters |
| MHz | megahertz |
| ppm | parts per million |
| δ | chemical shift |
| ° C. | degrees Celsius |
| J | coupling constant |
| min | minutes |
| hr | hours |
| RT | room temperature |
| ON | overnight |
| RBF | round bottom flask |
| CDCl₃ | deuterated chloroform |
| PEO | poly(ethylene oxide) |
| A-PEO₈-M | Allyl methyl PEO |
| CNT | carbon nanotube |
| PMDS | Pentamethyldisiloxane |
| HMTS | 1,1,3,3,5,5-hexamethyltrisiloxane |
| MTDS | methyltris(dimethylsiloxy)silane |
| TKDS | tetrakis(dimethylsiloxy)silane |
| TMDS | 1,1,3,3-tetramethyldisiloxane |
| D₄ | octamethylcyclotetrasiloxane |

Statistical Analysis. Reported values represent an average and standard deviation of N>3 measurements. Statistical analysis was performed using an ordinary one-way ANOVA followed by a Dunnett multiple comparison test and statistical significance was set at a p-value<0.05.

### Example 2

### Synthesis of Amphiphile Precursors

In the instant example, ODMS., 1-Star [ODMS]ₘ, 2-Star [ODMS]ₘ, 3-Star 10 [ODMS]ₘ, and 4-Star I[ODMS]ₘ were prepared using triflic acid-catalyzed ring-opening polymerizations of D₄ in the presence of suitable end-capping agents: TMDS, PMDS, HMTS, MTDS, and TKDS, respectively. Reagents were combined in sealed round bottom flasks (RBF), and 40 μL of triflic acid was added. The mixture was stirred (RT; ON), and was neutralized with the addition of 94 μL of hexamethyldisilazane (RT, 1 hr). The products were purified by filtration through qualitative filter paper and yielded clear, colorless liquids. Chemical structures of products were confirmed via ¹H NMR spectroscopy using a Bruker Avance Neo 400 MHz 5 spectrometer with an Ascend magnet, an automated tuning 5 mm broadband iProbe, operating in Fourier transform mode and with CDCl₃ as the standard.

ODMS₁₂. D₄ (21.72 g, 73.23 mmol), TMDS (3.28 g, 24.41 mmol) and triflic acid were reacted to yield the product. ¹H NMR (400 MHz, CDCl₃; δ, ppm): 0.05-0.10 (m, 72H, SiCH₃), 0.19 (d, J=2.8 Hz, 12H, OSi[CH₃]₂H), and 4.65-4.75 (m, 2H, SiH).

ODMS₂₄. D₄ (23.25 g, 78.37 mmol), TMDS (1.75 g, 13.06 mmol) and triflic acid were reacted to yield the product. ¹H NMR (400 MHz, CDCl₃; δ, ppm): 0.05-0.10 (m, 144H, SiCH₃), 0.19 (d, J=2.8 Hz, 12H, OSi[CH₃]₂H), and 4.65-4.75 (m, 2H, SiH).

ODMS₃₆. D₄ (23.80 g, 80.25 mmol), TMDS (1.20 g, 8.92 mmol) and triflic acid were reacted to yield the product. ¹H NMR (400 MHz, CDCl₃; δ, ppm): 0.05-0.10 (m, 216H, SiCH₃), 0.19 (d, J=2.8 Hz, 12H, OSi[CH₃]₂H), and 4.65-4.75 (m, 2H, SiH).

1-Star [ODMS]2. D₄ (21.43 g, 72.24 mmol), PMDS (3.57 g, 24.08 mmol) and triflic acid were reacted to yield the product. ¹H NMR (400 MHz, CDCl₃; δ, ppm): 0.06-0.09 (m, 81H, Si[CH₃]₃OSiCH₃), 0.19 (d, J=2.8 Hz, 6H, OSi[CH₃]₂H), 4.69-4.72 (m, 1H, SiH).

2-Star [ODMS]₆. D₄ (20.26 g, 68.29 mmol), HMTS (4.75 g, 22.76 mmol) and triflic acid were reacted to yield the product. ¹H NMR (400 MHz, CDCl₃; δ, ppm): 0.06-0.09 (m, 78H, Si[CH₃]₂[OSiCH3]₂), 0.19 (d, J=2.8 Hz, 12H, [OSi[CH₃]₂H]₂), 4.69-4.72 (m, 2H, [SiH]₂).

2-Star [ODMS]2. D₄ (22.38 g, 75.45 mmol), HMTS (2.62 g, 12.57 mmol) and triflic acid were reacted to yield the product. ¹H NMR (400 MHz, CDCl₃; δ, ppm): 0.06-0.09 (m, 150H, Si[CH₃]₂[OSiCH3]₂), 0.19 (d, J=2.8 Hz, 12H, [OSi[CH₃]₂H]₂), 4.69-4.72 (m, 2H, [SiH]₂).

3-Star [ODMS]₄. D₄ (19.20 g, 64.74 mmol), MTDS (5.80 g, 21.58 mmol) and triflic acid were reacted to yield the product. ¹H NMR (400 MHz, CDCl₃; δ, ppm): 0.06-0.09 (m, 75H, SiCH₃[OSiCH3]₃), 0.19 (d, J=2.8 Hz, 18H, [OSi[CH₃]₂H]₃), 4.69-4.72 (m, 3H, [SiH]₃).

3-Star [ODMS]2. D₄ (22.71 g, 76.58 mmol), MTDS (2.29 g, 8.51 mmol) and triflic acid were reacted to yield the product. ¹H NMR (400 MHz, CDCl₃; δ, ppm): 0.06-0.09 (m, 219H, SiCH₃[OSiCH3]₃), 0.19 (d, J=2.8 Hz, 18H, [OSi[CH₃]₂H]3), 4.69-4.72 (m, 3H, [SiH]₃).

4-Star [ODMS]₃. D₄ (18.26 g, 61.55 mmol), TKDS (6.74 g, 20.52 mmol) and triflic acid were reacted to yield the product. ¹H NMR (400 MHz, CDCl₃; δ, ppm): 0.06-0.09 (m, 72H, Si[OSiCH3]₄), 0.19 (d, J=2.8 Hz, 24H, [OSi[CH₃]₂H]₄), 4.69-4.72 (m, 4H, [SiH]₄).

4-Star [ODMS]₁₂. D₄ (22.89 g, 77.16 mmol), TKDS (2.11 g, 6.43 mmol) and triflic acid were reacted to yield the product. ¹H NMR (400 MHz, CDCl₃; δ, ppm): 0.06-0.09 (m, 288H, Si[OSiCH3]₄), 0.19 (d, J=2.8 Hz, 24H, [OSi[CH₃]₂H]₄), 4.69-4.72 (m, 4H, [SiH]₄).

### Example 3

### Synthesis of Amphiphiles with Linear Architecture

In the instant example, HDMS₀, HDMS₁₂, HDMS₂₄, HDMS₃₆, Triblock [DMS]12 were prepared using a one-step hydrosilylation protocol.

HDMS₀. HDMS₀ (H—Si-ODMS₀-b-PEO₈-OCH₃) was prepared using a one-step hydrosilylation protocol. Briefly, TMDS was reacted with A-PEO₈-M (1:1 molar ratio) via a Wilkinson's catalyzed regioselective hydrosilylation and purified.

HDMS₁₂, HDMS₂₄, and HDMS₃₆. HDMS₁₂ (H—Si-ODMS12-b-PEO₈-OCH₃), HDMS₂₄ (H—Si-ODMS₂₄-b-PEO₈-OCH₃), and HDMS₃₆ (H—Si-ODMS₃₆-b-PEO₈-OCH₃) were synthesized using a one-step hydrosilylation protocol. Briefly, ODMSₘ (m=12, 24, or 36) was reacted with A-PEO₈-M (1:1 molar ratio) via a Wilkinson's catalyzed regioselective hydrosilylation and purified.

Triblock [DMS]₁₂. Triblock [HDMS]12 (CH₃O-PEO₈-block-ODMS₁₂-block-PEO₈-OCH₃) was synthesized using a one-step hydrosilylation protocol. Briefly, the ODMS₁₂ tether underwent Karstedt's-catalyzed hydrosilylation with A-PEO₈-M (1:2 molar ratio). The purified product was clear, colorless.

### Example 4

### Synthesis of Amphiphiles with “Star” Architectures

In the instant example, 1-Star, 2-Star, 3-Star, and 4-Star amphiphiles were prepared. A designated amphiphile precursor and A-PEO₈M were dissolved in toluene (20 mL) in a sealed RBF with Karstedt's catalyst (50 μL) and heated to 80° C. After 12 hr, the catalyst was removed from the reaction mixture by adding activated charcoal and allowing to stir for 2 hr. The mixture was then filtered to remove the charcoal. After filtration, the volatiles were removed under reduced pressure and yielded a colorless liquid.

1-Star [DMS]12. A-PEO₈-M (7.56 g, 16.80 mmol), 1-Star [ODMS]12 (17.44 g, 16.80 mmol), and Karstedt's catalyst were reacted to yield the product. 1H NMR (400 MHz, CDCl₃; δ, ppm): 0.06-0.09 (m, 87H, Si[CH₃]₃OSiCH₃), 0.47-0.55 (m, 2H, SiCH₂CH₂CH₂), 1.56-1.64 (m, 2H, SiCH₂CH₂CH₂), 3.38 (s, 3H, OCH₃), 3.39-3.44 (t, J=6.9 Hz, 2H, SiCH₂CH₂CH₂), 3.52-3.70 (m, 34H, CH₂CH₂O).

2-Star [DMS]₆. A-PEO₈-M (11.26 g, 25.02 mmol), 2-Star [ODMS]₆ (13.74 g, 12.51 mmol), and Karstedt's catalyst were reacted to yield the product. 1H NMR (400 MHz, CDCl₃; δ, ppm): 0.06-0.09 (m, 90H, Si[CH₃]₂[OSiCH3]₂), 0.47-0.55 (m, 4H, SiCH₂CH₂CH₂), 1.56-1.64 (m, 4H, SiCH₂CH₂CH₂), 3.38 (s, 6H, OCH₃), 3.39-3.44 (t, J=6.9 Hz, 4H, 5 SiCH₂CH₂CH₂), 3.52-3.70 (m, 68H, CH₂CH₂O).

2-Star [DMS]₁₂. A-PEO₈-M (7.79 g, 17.31 mmol), 2-Star [ODMS]12 (17.21 g, 8.66 mmol), and Karstedt's catalyst were reacted to yield the product. ¹H NMR (400 MHz, CDCl₃; δ, ppm): 0.06-0.09 (m, 162H, Si[CH₃]₂[OSiCH3]₂), 0.47-0.55 (m, 4H, SiCH₂CH₂CH₂), 1.56-1.64 (m, 4H, SiCH₂CH₂CH₂), 3.38 (s, 6H, OCH₃), 3.39-3.44 (t, J=6.9 Hz, 4H, SiCH₂CH₂CH₂), 3.52-3.70 (m, 68H, CH₂CH₂O).

3-Star [DMS]₄. A-PEO₈-M (13.46 g, 29.90 mmol), 3-Star [ODMS]₄ (11.56 g, 9.97 mmol), and Karstedt's catalyst were reacted to yield the product. ¹H NMR (400 MHz, CDCl₃; δ, ppm): 0.06-0.09 (m, 93H, SiCH₃[OSiCH3]₃), 0.47-0.55 (m, 6H, SiCH₂CH₂CH₂), 1.56-1.64 (m, 6H, SiCH₂CH₂CH₂), 3.38 (s, 9H, OCH₃), 3.39-3.44 (t, J=6.9 Hz, 6H, SiCH₂CH₂CH₂), 3.52-3.70 (m, 102H, CH₂CH₂O).

3-Star [DMS]₁₂. A-PEO₈-M (7.87 g, 17.49 mmol), 3-Star [ODMS]12 (17.13 g, 5.83 mmol), and Karstedt's catalyst were reacted to yield the product. ¹H NMR (400 MHz, CDCl₃; δ, ppm): 0.06-0.09 (m, 237H, SiCH₃[OSiCH3]₃), 0.47-0.55 (m, 6H, SiCH₂CH₂CH₂), 1.56-1.64 (m, 6H, SiCH₂CH₂CH₂), 3.38 (s, 9H, OCH₃), 3.39-3.44 (t, J=6.9 Hz, 6H, SiCH₂CH₂CH₂), 3.52-3.70 (m, 102H, CH₂CH₂O).

4-Star [DMS]₃. A-PEO₈-M (14.91 g, 33.13 mmol), 4-Star [ODMS]₃ (10.09 g, 8.28 mmol), and Karstedt's catalyst were reacted to yield the product. ¹H NMR (400 MHz, CDCl₃; δ, ppm): 0.06-0.09 (m, 96H, Si[OSiCH3]4), 0.47-0.55 (m, 8H, SiCH₂CH₂CH₂), 1.56-1.64 (m, 8H, SiCH₂CH₂CH₂), 3.38 (s, 12H, OCH₃), 3.39-3.44 (t, J=6.9 Hz, 8H, SiCH₂CH₂CH₂), 3.52-3.70 (m, 136H, CH₂CH₂O).

4-Star [DMS]₁₂. A-PEO₈-M (7.91 g, 17.58 mmol), 4-Star |ODMS|12 (17.09 g, 4.40 mmol), and Karstedt's catalyst were reacted to yield the product. ¹H NMR (400 MHz, CDCl₃; δ, ppm): 0.06-0.09 (m, 312H, Si[OSiCH3]4), 0.47-0.55 (m, 8H, SiCH₂CH₂CH₂), 1.56-1.64 (m, 8H, SiCH₂CH₂CH₂), 3.38 (s, 12H, OCH₃), 3.39-3.44 (t, J=6.9 Hz, 8H, SiCH₂CH₂CH₂), 3.52-3.70 (m, 136H, CH₂CH₂O).

### Example 5

### Fabrication of SiHicone-CNT Composites

In the instant example, SiHicone-CNT composites were prepared. The CNTs (2 wt % w.r.t. Sylgard 184 part A and B, and DSPA) were added to a mixing cup along with the prescribed amount of Sylgard 184 part A and designated DSPA (5 wt % w.r.t. Sylgard 184 part A and B). The mixture was subsequently mixed in a FlackTek Inc. SpeedMixer™ (3500 rpm; 10 min). Next, Sylgard 184 part B was added at a 1:10 mass ratio with Sylgard 184 part A (per manufacturer's specifications). The mixture was again mixed (3500 rpm; 5 min) before being poured into a one-sided mold consisting of glass slide backing and polytetrafluoroethylene (PTFE) form (50×25×1 mm; McMaster-Carr). To degas the liquid film, the mold was then placed into a vacuum oven (RT; 1 min; 30 in. Hg) that was vented to 15 in. Hg. This was repeated for five cycles with maximum pressure (30 in. Hg) and consecutively held for 2.5, 3.5, 10, 10, and 10 min. Prior to curing a subsequent glass slide was placed on top to ensure smooth surfaces on both sides of the mold. To cure the degassed liquid film, the molds were placed in a preheated oven (145° C., 30 min) (per manufacturer's specifications). Final film thickness (t~2.5 or 1 mm) was controlled by PTFE mold thickness and volume of mixture added: mold t ~2.5 mm (vol~3.13 mL) and mold t~1 mm (vol~1.25 mL).

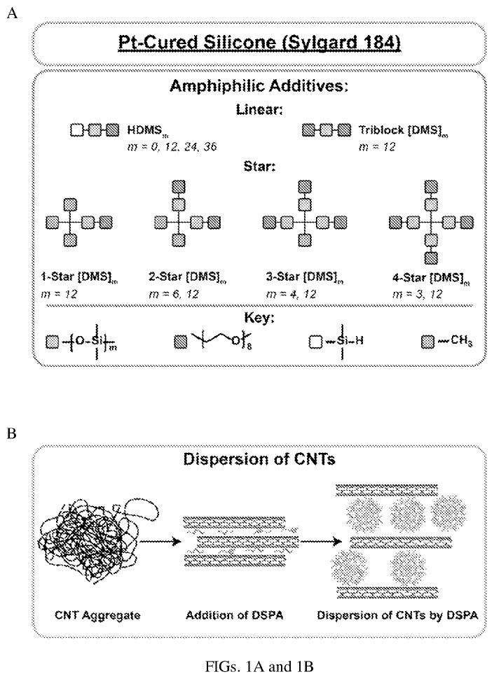

Twelve PEO-SAs of varying crosslinkability, architecture, siloxane tether length, and molar ratio of siloxane:PEO were synthesized (FIG. 1A). HDMSₘ PEO-SAs were crosslinkable (i.e., contained a silane group) while remaining PEO-SAs were not. The “Star” series varied in terms of the number of arms that emanate from a common core, with 1-Star and 2-Star effectively being linear in architecture while 3-Star and 4-Star are truly of a star architecture. SiHicone-CNT composites were prepared by combining each PEO-SA with an off-the-shelf addition cure silicone [Sylgard 184]. PEO-SAs were added at 5 wt % (w.r.t Sylgard 184) while CNTs were added at 2 wt % (w.r.t. Sylgard 184 and PEO-SA). A silicone-CNT composite prepared without a PEO-SA served as an “unmodified” control. Mixing of composites formulations was done with simple mixing (15 minutes total) without incorporation of solvents or any modification to the CNTs. Hereafter, composites are designated based on the PEO-SA used in fabrication.

### Example 6

### Characterization of SiHicone-CNT Composites

In the instant example, the characterization of SiHicone-CNT Composites was investigated.

Dielectric Properties—Conductivity and Impedance. Conductivity and impedance were evaluated at RT (Novocontrol Alpha impedance analyzer). Briefly, composite films were punched into discs (d~35 mm×t~1 mm) using a biopsy punch. Samples underwent a frequency sweep from 1-1×10⁷ Hz (49 point measurements in total), and conductivity (S/m) and impedance (Ohms) each recorded. DC conductivity (σ_{DC}) values were taken as the average of conductivity values from 1-10³ Hz.

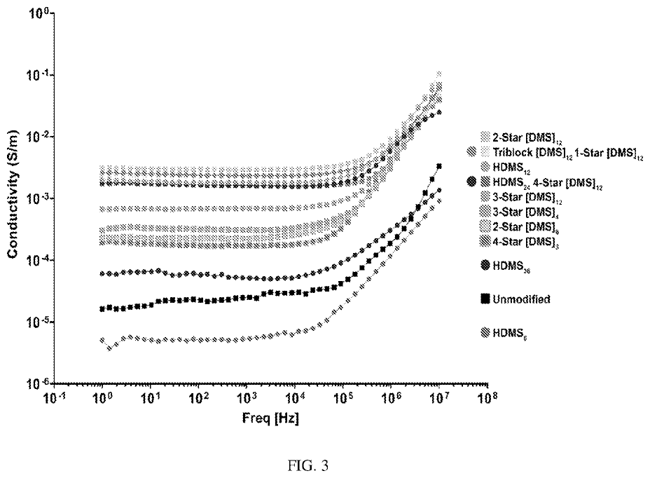

SiHicone-CNT dielectric properties were investigated to probe the ability of PEO-SAs to effectively disperse CNTs. All composite films showed a characteristic DC conductivity (σ_{DC}) plateau, indicating that CNTs were loaded above the percolation concentration (φ_{c}) (FIG. 3). φ_{c} is the minimum concentration of CNTs required to produce electrical signal, below which the silicone-CNT composites would have electrical properties similar to unmodified silicone. Additionally, a characteristic slope change was observed, indicative of the onset of polarization.

SiHicone-CNT conductivity value comparisons focused on σ_{DC}, as that is the region where properties are impacted by the extent of CNT dispersion. PEO-SA modified composites showed improved σ_{DC} compared to the unmodified control (i.e., no PEO-SA) (FIG. 3, Table 1). The exception was HDMS₀ which showed the lowest σ_{DC} (5.11×10⁻⁶ S/m), ~4× lower than the control composite (2.10×10⁻⁵ S/m). Without being bound by any theory, the absence of a siloxane tether may diminish the compatibility of HDMS₀ with the silicone matrix and may lead to appreciable phase separation. Notably, irrespective of crosslinkability, architecture, or siloxane:PEO, the composites with the highest conductivity were those prepared with PEO-SAs containing siloxane tethers of 12 or 24 repeat units: (2-Star [DMS]n, 3.01×10⁻³ S/m>Triblock [DMS]₁₂, 2.46×10⁻³ S/m>1-Star [DMS]₁₂, 2.39×10⁻³ S/m>HDMS₁₂. 1.88×10⁻³ S/m>HMDS₂₄, 1.71×10⁻³ S/m>4-Star [DMS]n, 1.70×10⁻³ S/m>3-Star [DMS]n, 6.84×10⁻⁴ S/m).

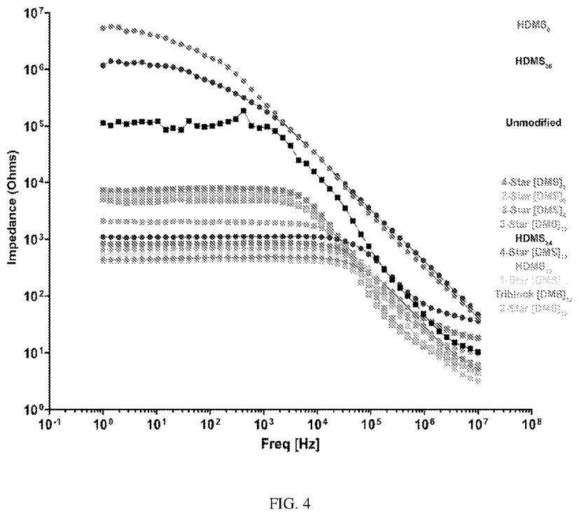

Those with longer siloxane tethers (HDMS₃₆, 5.99×10⁻⁵ S/m) or shorter siloxane tethers (2-Star [DMS]₆, 2.28×10⁻⁴ S/m; 3-Star [DMS]₄, 3.25×10⁻⁴ S/m; 4-Star [DMS]₃, 1.82×10⁻⁴ S/m) showed decreased performance. As conductivity increased, impedance corresponding decreased for modified silicone-CNT composites (FIG. 4).

TABLE 1
Per FIG. 3, concentration of PEO-SAs at 5 wt % loading in silicone-
CNT composite films and their respective DC conductivity values.

| | Concentration | |
|---|---|---|
| | (mM) | σ_{DC} (S m⁻¹) |
| Sylgard 184 | N/A | 2.10 × 10⁻⁵ ± 2.98 × 10⁻⁶ |
| HDMS₀ | 88.14 | 5.11 × 10⁻⁶ ± 3.94 × 10⁻⁷ |
| HDMS₁₂ | 34.94 | 1.88 × 10⁻³ ± 7.31 × 10⁻⁵ |
| HDMS₂₄ | 21.79 | 1.71 × 10⁻³ ± 6.90 × 10⁻⁵ |
| HDMS₃₆ | 15.83 | 5.99 × 10⁻⁵ ± 4.61 × 10⁻⁶ |
| Triblock [DMS]₁₂ | 26.77 | 2.46 × 10⁻³ ± 9.50 × 10⁻⁵ |
| 1-Star [DMS]₁₂ | 34.61 | 2.39 × 10⁻³ ± 2.76 × 10⁻⁵ |
| 2-Star [DMS]₁₂ | 17.83 | 3.01 × 10⁻³ ± 5.82 × 10⁻⁵ |
| 3-Star [DMS]₁₂ | 12.01 | 6.84 × 10⁻⁴ ± 8.50 × 10⁻⁶ |
| 4-Star [DMS]₁₂ | 9.05 | 1.70 × 10⁻³ ± 4.75 × 10⁻⁵ |
| 2-Star [DMS]₆ | 25.77 | 2.28 × 10⁻⁴ ± 3.13 × 10⁻⁶ |
| 3-Star [DMS]₄ | 20.53 | 3.25 × 10⁻⁴ ± 1.05 × 10⁻⁵ |
| 4-Star [DMS]₃ | 17.06 | 1.82 × 10⁻⁴ ± 9.60 × 10⁻⁶ |

Scanning Electron Microscopy (SEM). Film cross sections (t~2.5 mm) were evaluated via SEM. Samples were freeze fractured and subsequently subjected to Au—Pt coating (~12 nm) prior to imaging. Images were obtained with a Tescan Vega 3 SEM (accelerating voltage of 10 kV). Aggregate size was estimated using ImageJ.

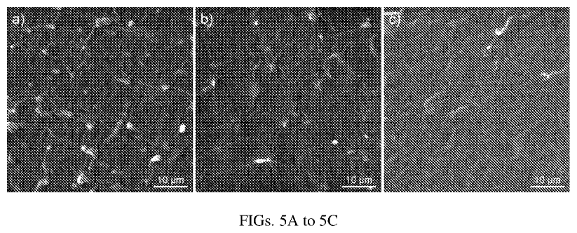

SEM analysis was used to confirm that the observed increase in conductivity was caused by improved CNT dispersion. Cross-section images were evaluated for composites. Composites prepared with PEO-SAs were associated with a range of distinct conductivities: HDMS₀ (worst), HDMS₃₆ (middling), and 2-Star [DMS]₁ (best) (FIGS. 5A to 5C). HDMS₀ showed large CNT aggregates (d~2,000-5,000 nm) (FIG. 5A). The HDMS₃₆ exhibited relatively fewer and smaller CNT aggregates (d~1,000-3,000 nm) (FIG. 5B). Finally, 2-Star [DMS]₂ showed extremely small aggregates (d~80-100 nm) (FIG. 5C). As dispersion improved, prevalence and size of CNT clusters decreased in the order HDMS₀>HDMS₃₆>2-Star [DMS]₁₂ Without being bound by any theory, these results may support that PEO-SAs can effectively separate large CNT aggregates, potentially allowing for increased dispersion in the bulk and potentially resulting in improved conductivity.

Refractive Index (RI). RI was evaluated with a J.A. Woollam Co., Inc. Gu-SE Ellipsometer. Briefly, a liquid DSPA was thinly spread on the surface of an unpolished glass substrate. Resultant light scattering was fit to a Cauchy model. The values obtained were used in the characterization of micelle size by dynamic light scattering (DLS) (Table 2).

TABLE 2
Refractive index measurements of liquid
PEO-SAs at a wavelength of 589 nm.

| | Refractive Index @ |
|---|---|
| | 589 nm |
| HDMS₀ | 1.444 ± 0.003 |
| HDMS₁₂ | 1.421 ± 0.002 |
| HDMS₂₄ | 1.412 ± 0.001 |
| HDMS₃₆ | 1.409 ± 0.000 |
| Triblock [DMS]₁₂ | 1.429 ± 0.001 |
| 1-Star [DMS]₁₂ | 1.430 ± 0.013 |
| 2-Star [DMS]₁₂ | 1.429 ± 0.002 |
| 3-Star [DMS]₁₂ | 1.417 ± 0.003 |
| 4-Star [DMS]₁₂ | 1.424 ± 0.003 |
| 2-Star [DMS]₆ | 1.427 ± 0.003 |
| 3-Star [DMS]₄ | 1.465 ± 0.013 |
| 4-Star [DMS]₃ | 1.439 ± 0.009 |

Micelle Formation—Dynamic Light Scattering (DLS). Micelle size was examined by DLS. Briefly, the prescribed amount of DSPA was added to a 20 mL scintillation with 2 g of hexane. The mixture was stirred using a vortex mixer and allowed to sit on a shaker plate (24 hr, 120 rpm) prior to testing. A solution (1.5 mL) was pipetted into a glass cuvette (PCS1115; Malvern Panalytical Zetasizer Nano ZS). Testing was conducted at 25° C. utilizing non-invasive back-scatter (NIBS) at 175° C. The reported values are an average of three measurements taken from aliquots of the same solution of DSPA in hexane.

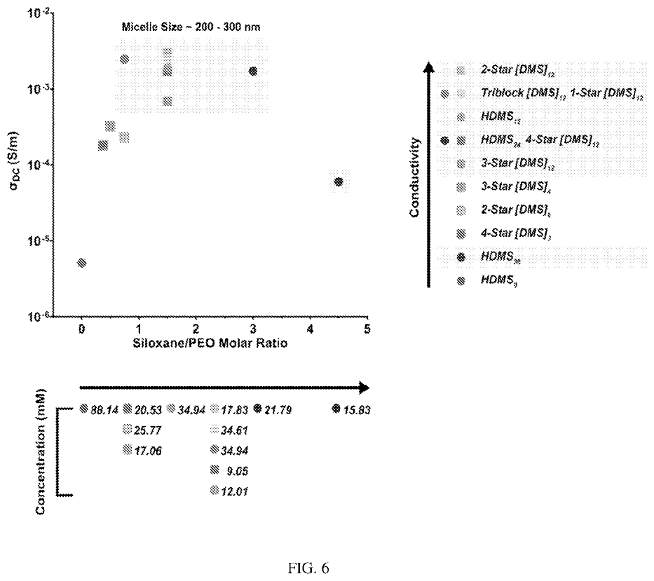

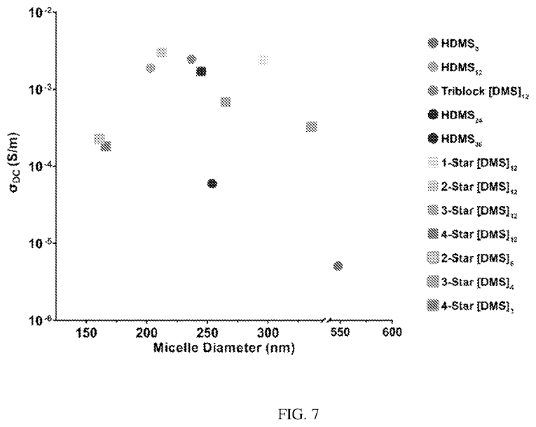

Without being bound by any theory, PEO-SA micelle formation and size may play a critical role in CNT dispersion in silicone composites through an excluded volume effect. Thus, DLS was used first used to investigate PEO-SA micelle size. Measurements were conducted with hexane solutions as the turbidity of Sylgard 184 was prohibitive for DLS. The concentration of each PEO-SA in hexane was equivalent to that in the silicone-CNT composites (FIG. 6, Table 1). The micelle size was then plotted versus σ_{DC} (FIG. 7, Table 3). Interestingly, PEO-SAs micelles with diameters~200-300 nm correlated to composites with the highest resulting σ_{DC}, the only exception being HDMS₃₆. PEO-SAs with micelle sizes outside of this range produced composites with appreciably diminished conductivity. Furthermore, a PEO-SA siloxane:PEO ratio between 0.75-3.00 formed ~200-300 nm micelles (FIG. 6, Table 3). Without being bound by any theory, these results may indicate that the siloxane:PEO ratio is one of the main factors impacting micelle diameter, as these trends exist independent of PEO-SA architecture, molecular weight, and crosslinkability.

TABLE 3
Per FIG. 6, micelle diameter, siloxane:PEO
ratio, and σDC of PEO-SAs.

| | Diameter | Siloxane:PEO | |
|---|---|---|---|
| | (nm) | Ratio | σ_{DC} (S m⁻¹) |
| HDMS₀ | 548 ± 40 | 0.00 | 5.11 × 10⁻⁶ ± 3.94 × 10⁻⁷ |
| HDMS₁₂ | 203 ± 1 | 1.50 | 1.88 × 10⁻³ ± 7.31 × 10⁻⁵ |
| HDMS₂₄ | 245 ± 0 | 3.00 | 1.71 × 10⁻³ ± 6.90 × 10⁻⁵ |
| HDMS₃₆ | 254 ± 11 | 4.50 | 5.99 × 10⁻⁵ ± 4.61 × 10⁻⁶ |
| Triblock | 237 ± 1 | 0.75 | 2.46 × 10⁻³ ± 9.50 × 10⁻⁵ |
| [DMS]₁₂ | | | |
| 1-Star | 295.7 ± 5 | 1.50 | 2.39 × 10⁻³ ± 2.76 × 10⁻⁵ |
| [DMS]₁₂ | | | |
| 2-Star | 212 ± 1 | 1.50 | 3.01 × 10⁻³ ± 5.82 × 10⁻⁵ |
| [DMS]₁₂ | | | |
| 3-Star | 265 ± 4 | 1.50 | 6.84 × 10⁻⁴ ± 8.50 × 10⁻⁶ |
| [DMS]₁₂ | | | |
| 4-Star | 245 ± 3 | 1.50 | 1.70 × 10⁻³ ± 4.75 × 10⁻⁵ |
| [DMS]₁₂ | | | |
| 2-Star | 161.5 ± 1 | 0.75 | 2.28 × 10⁻⁴ ± 3.13 × 10⁻⁶ |
| [DMS]₆ | | | |
| 3-Star | 337 ± 51 | 0.50 | 3.25 × 10⁻⁴ ± 1.05 × 10⁻⁵ |
| [DMS]₄ | | | |
| 4-Star | 166 ± 56 | 0.375 | 1.82 × 10⁻⁴ ± 9.60 × 10⁻⁶ |
| [DMS]₃ | | | |

Critical Micelle Concentration (CMC). CMC was examined by viscosity. Briefly, Sylgard 184 part A and B were added into a mixing cup at a 10:1 (per manufacturers specifications) followed by the designated concentration of DSPA. The mixture was subsequently mixed in a FlackTek Inc. SpeedMixer™ (3500 rpm; 1 min). Measurements were recorded on an Anton Parr Physica MCR 301 (gap: 1 mm; measuring plate: 10 mm; sample: ~0.5 g). Samples were sheared at a constant rate (0.01 Hz, 360 s) to investigate shear rate independent viscosity. The reported values are an average of three specimens taken from the same batch of uncured silicone. CMC was taken at the local minima of the specific viscosity*concentration⁻¹ (Nₛₚ/C) vs. concentration (C) plot.

To confirm that micellular formation occurred, CMC was examined for the aforementioned modified composites of varying conductivities: HDMS₀ (worst), HDMS₃₆ (middling), and 2-Star [DMS]₂ (best). For uncured formulations, specific viscosity per concentration (Nₛₚ C⁻¹) was graphed versus concentration (C) with CMC taken at local minima.

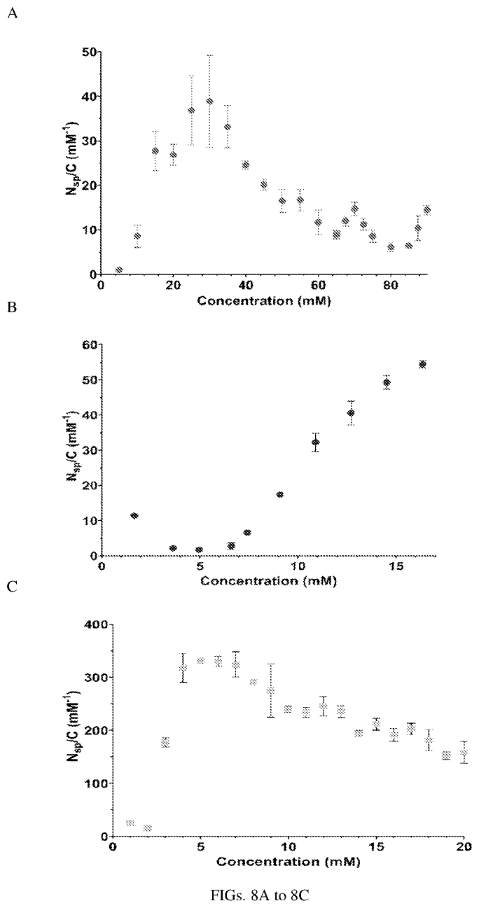

All three formulations exhibited CMC values at concentrations lower than that of the PEO-SA added (FIGS. 8A to 8C). Thus, for these modified silicone-CNT composites, the PEO-SAs had indeed formed micelles but of varying diameters depending on siloxane:PEO ratio. While all PEO-SAs were incorporated at 5 wt %, their molar concentrations varied in the final composites (FIG. 6). Composites with highest conductivities were not characterized by particularly high or low molar concentrations. Without being bound by any theory, beyond the CMC and formation of micelles, molar concentration did not impact conductivity.

Bulk Mechanical Properties. Compressive tests were evaluated at RT with an Instron 5944 and run in accordance with ASTM D695-15. Briefly, composite films were punched into discs (d~6 mm×t 2.5 mm) using a biopsy punch. An initial preload of 0.2 N was applied to each sample and the strain subsequently zeroed. Samples (N=5) were compressed at a rate of 1 mm min⁻¹ until fracture. The elastic modulus (E) was calculated using the linear region (0-10%) of the stress-strain curve.

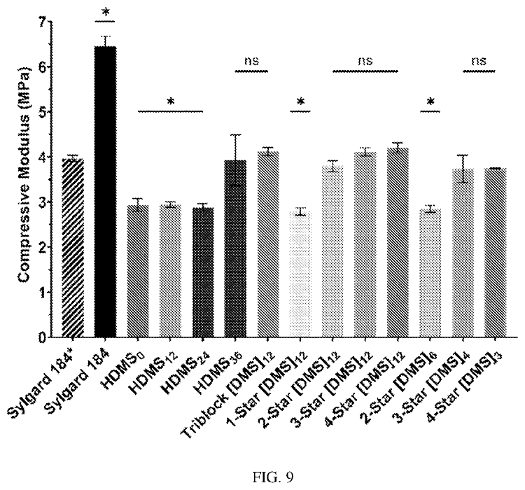

For utility as dry, flexible skin electrodes, silicone-CNT composites prepared with PEO-SAs must not significantly increase the compressive modulus such that they are in contact with the skin. Sylgard 184, without the inclusion of either CNTs or PEO-SAs, showed a compressive modulus ~4.0 MPa (FIG. 9, Table 4). The modulus unmodified composite (i.e., Sylgard 184 and CNTs) expectedly increased to ~6.5 MPa. When any of the 12 PEO-SAs were incorporated, all modified silicone-CNT composites exhibited moduli statistically similar or lower than the neat Sylgard 184. Without being bound by any theory, these results may be caused by plasticization effects from the PEO-SAs and their interactions with the CNTs as this effect was not seen in work involving Pt-catalyzed silicones.

TABLE 4
Per FIG. 9, compressive modulus of unmodified silicone (Sylgard
184*), unmodified silicone loaded with CNTs (Sylgard 184)
and silicones modified with CNTS and PEO-SAs.

| | Compressive Modulus |
|---|---|
| | (MPa) |
| Sylgard 184* | 3.97 ± 0.07 |
| Sylgard 184 | 6.46 ± 0.21 |
| HDMS₀ | 2.93 ± 0.14 |
| HDMS₁₂ | 2.94 ± 0.06 |
| HDMS₂₄ | 2.88 ± 0.08 |
| HDMS₃₆ | 3.93 ± 0.56 |
| Triblock [DMS]₁₂ | 4.12 ± 0.09 |
| 1-Star [DMS]₁₂ | 2.79 ± 0.08 |
| 2-Star [DMS]₁₂ | 3.80 ± 0.12 |
| 3-Star [DMS]₁₂ | 4.11 ± 0.09 |
| 4-Star [DMS]₁₂ | 4.20 ± 0.12 |
| 2-Star [DMS]₆ | 2.85 ± 0.08 |
| 3-Star [DMS]₄ | 3.74 ± 0.30 |
| 4-Star [DMS]₃ | 3.74 ± 0.01 |

### Example 7

### Fabrication and Characterization of Skin Electrodes

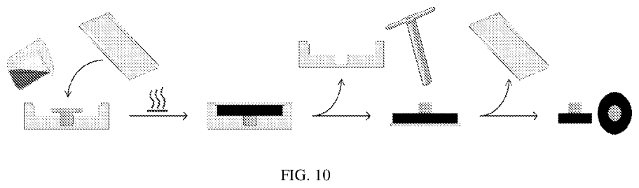

In the instant example, Skin Electrodes were prepared and investigated. The silicone-CNT composite mixtures used to fabricate electrodes were prepared in the same manner as the films. Electrodes were prepared with composites having the highest conductivities (Triblock [DMS]₁₂, 1-Star [DMS]₁₂, and 2-Star [DMS]₁₂) and worst conductivity (HDMS₀) as well as with unmodified composite (i.e., no PEO-SA). Electrodes were fabricated through drop casting of films into a PTFE mold with an Ag/AgCl button embedded in the center (FIG. 10). A mixture was poured into an open face mold consisting of PTFE backing (50×25×1 mm; McMaster-Carr) with holes (d~3 mm) drilled 15 mm apart and a PTFE form (50×25×2.5 mm; McMaster-Carr). Ag/AgCl snap buttons (S-9002/300/0; Select Engineering Inc.) were placed into the holes prior to filling the mold with material. After degassing (as per films), a glass plate was placed on top. Following curing, buttons were cut out using a biopsy punch to yield electrodes (d 10 mm, t~2.5 mm).

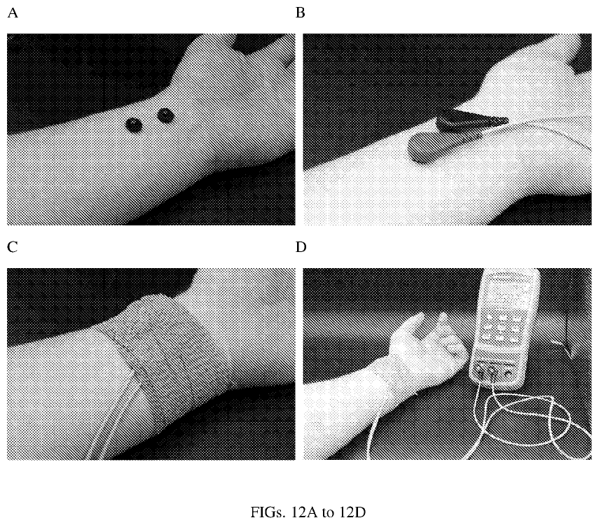

Skin-Electrode Impedance. Skin-electrode impedance was measured using a Keysight U1700 LCR Meter at 10 kHz. A pair of analogous electrodes (~20 mm apart) were placed on the user's forearm (IRB2017-0335D) and secured with a wrap (3M™ Corban Self-Adhesive Wrap) (FIGS. 12A to 12D). The wrap was marked to ensure the same force was applied to each electrode pair. Electrode pair were allowed to sit on skin for 90 sec prior to measurements being recorded. After each measurement, the wrap and electrodes were removed from the user. Ethyl alcohol gauze were used to clean the skin and remove any sweat that may have accumulated. The reported skin impedance values are the average of three measurements taken with each pair of electrodes.

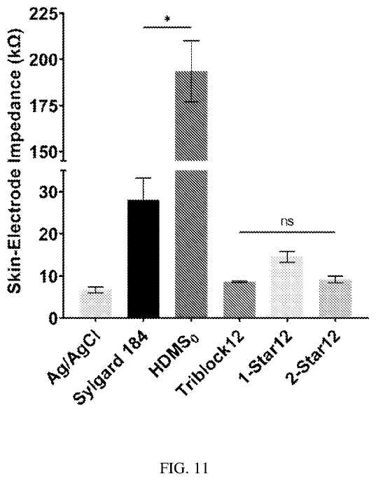

The metal electrodes had a skin-electrode impedance ~7 kΩ (FIG. 11, Table 5). Both the unmodified composite and HDMS₀ showed statistically higher skin-electrode 10 impedances of ~28 kΩ and ~194 kΩ, respectively. These results were expected based on their low conductivities. The composites with the highest conductivities displayed improved skin impedance that were statistically similar to the metal electrode: Triblock [DMS]₁₂ (~9 kΩ), 1-Star [DMS]₁₂ (~15 kΩ) and, 2-Star [DMS]₂ (~9 kΩ).

TABLE 5
Per FIG. 11, skin-electrode impedance of electrodes comprised
of Ag/AgCl, unmodified silicone-CNT composite (Sylgard 184),
and silicone-CNT composites modified with PEO-SAs at 10 kHz.

| | Skin-Electrode |
|---|---|
| | Impedance (kΩ) |
| Ag/AgCl | 6.69 ± 0.67 |
| Sylgard 184 | 28.1 ± 5.14 |
| HDMS₀ | 194 ± 16.6 |
| Triblock [DMS]₁₂ | 8.65 ± 0.17 |
| 1-Star [DMS]₁₂ | 14.5 ± 1.30 |
| 2-Star [DMS]₁₂ | 9.15 ± 0.82 |

1. An amphiphilic siloxane compound comprising:
a siloxane tether segment; and a polymer segment;
wherein the amphiphilic siloxane compound is of the formula I 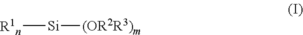
wherein
each R¹, when present, is independently selected from the group consisting of hydrogen, alkyl, phenyl, vinyl, allyl, alkoxy, acrylate, methacrylate, amine, carboxylic acid, epoxide, and R³;
R² is the siloxane tether segment;
R³ is the polymer segment;
n is an integer of 0, 1, 2, or 3; m is an integer of 1, 2, 3, or 4; and n+m=4.

2. The amphiphilic siloxane compound of claim 1, wherein the polymer segment (R³) comprises a poly(alkylene oxide), polyoxazolines (POx), a poly(vinyl alcohol) (PVA), a poly(N-vinyl pyrrolidinone) (PVP), a poly(glutamic acid) (PGA), a polyacrylamide (PAM), a poly(N-isopropylacrylamide) (PNIPAAm), a polyethyleneimine (PEI), a poly(2-hydroxy ethyl methacrylate) (PHEMA), a alginate, a poly(2-methacryloyloxyethyl phosphorylcholine) (PMPC), a polylysine, polycarboyxbetaine, and any combination thereof.

3. (canceled)

4. The amphiphilic siloxane compound of claim 1, wherein the polymer segment (R³) further comprises a linker (L).

5. The amphiphilic siloxane compound of claim 1, wherein the polymer segment (R³) is of the formula 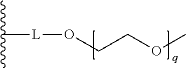
wherein
L is a linker selected from alkylene, alkenylene, or alkynylene; and
q is an average number of repeat units of 3 to 24.

6. (canceled)

7. (canceled)

8. (canceled)

9. The amphiphilic siloxane compound of claim 1, wherein each R¹ is independently H, C₁-C₆ alkyl, or R³.

10. (canceled)

11. (canceled)

12. (canceled)

13. (canceled)

14. The amphiphilic siloxane compound of claim 5, wherein R¹ is R³, and each q is 8 or 16.

15. (canceled)

16. (canceled)

17. The amphiphilic siloxane compound of claim 1, wherein the siloxane tether segment is of the formula 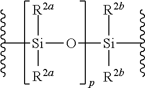
wherein
each R^{2a} and R^{2b} is independently selected from the group consisting of hydrogen, halo, alkyl, haloalkyl, alkoxy, haloalkoxy, aryl, aryl, and heteroaryl; and
p is an average number of repeat units of 3 to 40.

18. (canceled)

19. (canceled)

20. The amphiphilic siloxane compound of claim 17, wherein p is 3 to 36.

21. The amphiphilic siloxane compound of claim 20, wherein p is 12.

22. The amphiphilic siloxane compound of claim 1, wherein the amphiphilic siloxane compound is of the formula II 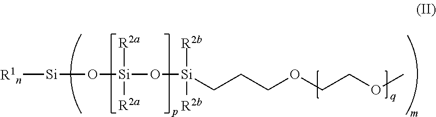
wherein
each R¹, when present, is independently selected from the group consisting of hydrogen, alkyl, phenyl, vinyl, allyl, alkoxy, acrylate, methacrylate, amine, carboxylic acid, epoxide, and R³;
each R^{2a} and R^{2b} is independently selected from the group consisting of hydrogen, halo, alkyl, haloalkyl, alkoxy, haloalkoxy, aryl, and heteroaryl;
R³, when present, is 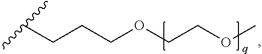
wherein
p is an average number of repeat units of 3 to 40;
each q is an average number of repeat units of 3 to 24;
n is an integer of 0, 1, 2, or 3; m is an integer of 1, 2, 3, or 4; and n+m=4.

23. (canceled)

24. The amphiphilic siloxane compound of claim 22, wherein n is 2, and two of R¹ are each methyl.

25. (canceled)

26. The amphiphilic siloxane compound of claim 1, selected from 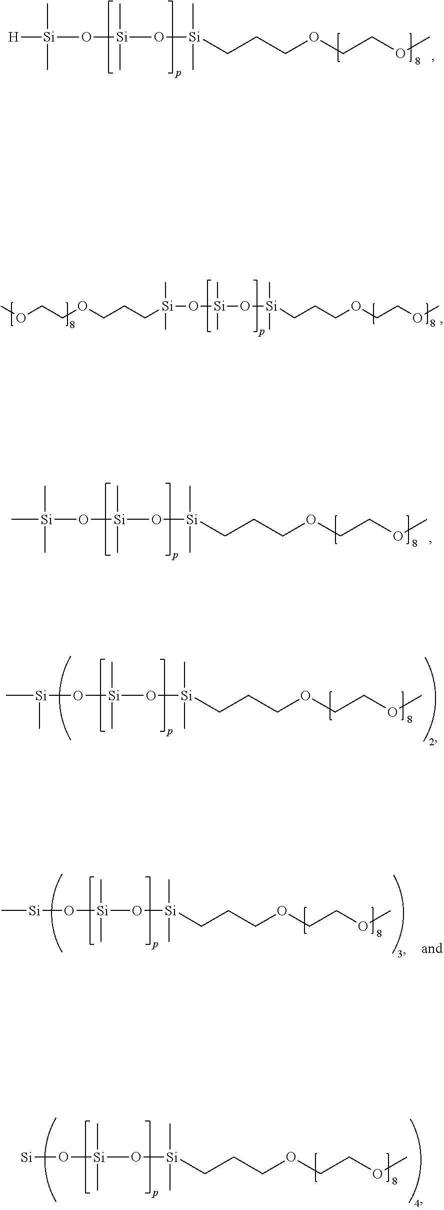
wherein p is an average number of repeat units of 3 to 36.

27. (canceled)

28. A mixture comprising the amphiphilic siloxane compound according to claim 1 blended with
a base polymer, and
a filler.

29. The mixture of claim 28, wherein the amphiphilic siloxane compound is covalently crosslinked with the base polymer.

30. The mixture of claim 28, wherein the amphiphilic siloxane compound is covalently crosslinked with a surface to provide a coating of the surface.

31. The mixture of claim 28, wherein the base polymer is selected from the group of an acrylic, an alkyd, an epoxy, a polyurethane, an acrylic aliphatic urethane, a polyurea, a silicone, a natural or synthetic rubber, a nylon, a nitrocellulose, a polyamide, a polycarbonate, a polyethylene, a polypropylene, a polyester, a polyvinyl chloride, a phenolic, a latex, and any combination thereof.

32. The mixture of claim 31, wherein the base polymer is a silicone.

33. The mixture of claim 28, wherein the filler is selected from the group of a carbon nanotube, graphite, graphene, carbon black, a metal filler, a ceramic filler, a metal-coated filler, Teflon, a pigment, and any combination thereof.

34. The mixture of claim 28, wherein the mixture does not comprise a solvent.

35. The mixture of claim 28, wherein the mixture further comprises a solvent.
